(19) United States
(12) Patent Application Publication
(10) Pub. No.: US 2012/0213956 A1
(43) Pub. Date: Aug. 23, 2012

(54) FUGITIVE ADHESIVE AND METHOD

(75) Inventors: William L. Bunnelle, Ham Lake, MN (US); Keith Knutson, St. Paul, MN (US); Thomas H. Quinn, St. Paul, MN (US)

(73) Assignee: Adherent Laboratories, Inc., St. Paul, MN (US)

(21) Appl. No.: 13/033,092

(22) Filed: Feb. 23, 2011

(51) Int. Cl. B65B 53/00; C09J 131/04; C09J 153/02; B32B 1/02; B32B 27/04; B32B 3/10; B32B 7/12; B32B 3/26; B32B 3/06; B32B 21/08; B32B 29/00; B32B 15/08; B32B 37/12; B32B 38/00; B32B 38/10; B65B 11/00; C09J 11/06

(52) U.S. Cl. 428/34.9; 524/313; 428/35.7; 428/484.1; 428/195.1; 428/317.7; 428/100; 428/485; 428/486; 428/467; 156/327; 156/280; 156/272.2; 156/182; 156/247; 53/461

(57) ABSTRACT

Described herein are fugitive hot melt adhesive compositions having a substantial weight percent of renewable plant-based content. The adhesive compositions impart high initial adhesive bond strength between an object and a substrate quickly after application in the molten state, wherein the adhesive bond strength is spontaneously substantially reduced to a very low or near zero level after a short time, for example between about 1 minute and 60 minutes after application. Methods of use and articles formed using the compositions are also described.

### FIELD OF THE INVENTION

The invention is a fugitive adhesive, method of forming assemblies using the fugitive adhesive, and assemblies formed using the fugitive adhesive. Non-permanently bonding adhesives, often called fugitive or temporary adhesives, are employed in industrial applications for temporarily bonding an object to a substrate. Fugitive adhesives are compositions that impart acceptable initial bond strength between an object and a substrate. Over time, due to the inherent properties of the fugitive adhesive formulation, the initial bond strength is reduced or is eliminated between the object and the substrate.

### BACKGROUND

Hot melt adhesives are typically thermoplastic materials that are heated to a molten state prior to their application. While in the molten state the adhesives are applied on a first surface which is then contacted with a second surface. As the molten conventional adhesive cools and solidifies, a permanent bond can form. In contrast to traditional hot melt adhesives, fugitive or non-permanent hot melt adhesives (“fugitive adhesives”) form a bond between a first and second surface where the bond persists for a controlled, but relatively short, period of time. Fugitive adhesives are commonly used in industrial processes wherein it is desirable for the adhesive bond to hold two items together until completion of the industrial process. For example, one use of fugitive hot melt adhesives is to hold an object or objects to a packaging substrate for sufficient time to assemble the object(s) and substrate into a packaging unit, wherein the bond loses most or all bond strength after assembly is complete. The non-permanent adhesive is intentionally formulated such that it loses its bonding properties or the adhesive bond fails after a period of time that is typically seconds to days in duration. In some cases, after bond failure, the adhesive itself leaves little or no residue, or adhesive mark, on the items to which it was applied. In some cases, the adhesive residue itself falls from the substrate for easy disposal.

The function and corresponding property of the fugitive adhesive in packaging is two-fold. In the first function, the fugitive adhesive holds an object in place on a substrate. For example, a plurality of objects is bonded on a corrugated cardboard surface to form an assembly. The fugitive adhesive forms a bond that is sufficiently strong, and lasts for a long enough time for another operation to take place, for example, a shrink-wrap can be formed over the objects and cardboard in the assembly. In this mode, the fugitive adhesive must form a bond between the cardboard surface and the objects. The bond must have sufficient adhesive and cohesive strength to hold the objects in place on the cardboard surface until the assembly can be shrink-wrapped. In the second function, to continue the above example after the shrink-wrap process of the objects is complete, the fugitive adhesive must lose sufficient adhesion such that the object can be removed from the package unit without either substrate or adhesive residue transfer to the object. In many cases, the adhesive residue drops off of the surface of either the object or the substrate during the discarding of the packaging; in some cases, it drops off both surfaces. In continuing the above example, this would allow the objects to be removed from the packaging, for example by a consumer, with the apparent feel of an absence of adhesive.

While hot melt adhesives are widely known throughout the industry, and fugitive hot melt adhesive formulations have been described in general, a substantial need exists to provide a fugitive adhesive wherein certain properties, such as bond strength, extent of bond release, and other properties, are improved over the properties of known fugitive adhesives. A substantial need exists to provide a fugitive adhesive that can provide the properties described above during manipulation of objects at elevated temperatures. Additionally, there is a long felt need to employ fugitive adhesive compositions that include sustainably sourced plant-based materials.

### BRIEF SUMMARY OF THE INVENTION

We have found that the use of certain amounts of hydrogenated plant oils or waxes, in combination with traditional polymers and tackifying resins, results in formulations supplying useful fugitive adhesive properties. In some embodiments, the fugitive adhesive compositions of the invention contain a base polymer, and about 40% to 80% by weight of the formulation of a vegetable based wax; wherein the adhesive composition forms a non-permanent or fugitive bond with a target substrate to provide an initial level of adhesion sufficient for an intended use, and wherein over a period of up to 60 minutes, in embodiments about 1 to 60 minutes, the adhesion level of the adhesive is reduced to the point where the bond fails adhesively to a substrate without leaving residue on the substrate, or the adhesion is reduced to an unmeasurable level, or zero. In some embodiments, the fugitive adhesive compositions of the invention further contain a tackifier. In embodiments, the base polymer is a styrenic block copolymer (SBC) or an ethylene copolymer. Fugitive adhesive compositions of the invention are characterized by a relatively sharp melt transition, a controllable “fugitive adhesive bond time,” that is, a short and predictable duration wherein the adhesive bond is functional, a suitable initial adhesive bond strength, and an ability to lose adhesion to a substrate in a predictable manner. The vegetable wax supplies some of these characteristics of a sharp melting point and a controllable fugitive adhesive bond time. The wax provides control over the overall viscosity of the adhesive to allow for the proper application or coating of the non-permanent adhesive on the intended substrate and is stable at hot melt application temperatures commonly employed in the industry.

The invention contemplates an article that is an assembly or a finished assembly. The assembly includes a) one or more containers, items, or components; b) one or more substrates; and c) one or more areas having a fugitive adhesive composition disposed between the one or more containers, items, or components, and the one or more substrates. The finished assembly further includes one or more means to hold the assembly in the desired arrangement after the fugitive adhesive of the invention loses its adhesive properties. In some embodiments the assembly or the finished assembly further contains one or more additional items.

The invention contemplates a method of forming an assembly that includes a) applying a fugitive adhesive of the invention to a substrate; b) arranging one or more containers, items, or components in a desired arrangement; and c) affixing the one or more containers, items, or components to the substrate to form an assembly. The fugitive adhesive of the invention acts to adhesively and cohesively hold the one or more containers, items, or components in the arrangement, wherein after a defined period of time the goods, items, or components are adhesively released. The fugitive adhesive of the invention stabilizes the one or more containers, items, or components in the desired configuration while one or more operations, for example handling, packaging, and the like is carried out; the fugitive adhesive then releases the one or more containers, items, or components soon after the one or more operations are completed. Thus, the invention further contemplates the formation of a finished assembly, wherein the finished assembly is characterized by carrying out the one or more operations on the assembly, followed by loss of adhesion of the fugitive adhesive of the invention. Thus, in some embodiments, the assembly is referred to as a “temporary assembly” while the assembly after completing the one or more operations is referred to as the “finished assembly.”

### BRIEF DESCRIPTION OF THE DRAWINGS

FIG. 1 is a schematic view illustrating the protocol used to test the fugitive adhesive compositions of the invention.

FIGS. 2 and 3 are schematic views illustrating adhesive applications of the invention.

FIGS. 4 and 5 are orthogonal views illustrating methods of using the adhesive compositions of the invention.

FIGS. 6 and 7 are isometric views of articles of the invention.

### DETAILED DESCRIPTION OF THE INVENTION

The invention contemplates hot melt adhesive formulations that are fugitive adhesives; wherein the fugitive adhesive formulations contain hydrogenated plant oils or waxes in combination with traditional polymers and tackifying resins. In embodiments, the fugitive adhesive composition of the invention contains a) a base polymer, and b) at least about 40% by weight relative to the total weight of the composition, for example about 40%-80% by weight relative to the total weight of the composition of a vegetable wax; wherein the fugitive adhesive composition forms an initial bond with a target substrate sufficient for an intended use and wherein the adhesion is fugitive within up to 60 minutes, defined herein as the “fugitive adhesive bond time” as determined by the Fugitive Adhesion test, described below. In some embodiments, the fugitive adhesive bond time is between about 1 minute and 60 minutes. In some embodiments, the fugitive adhesive compositions are characterized by the absence of a tackifying resin (or tackifier). In some embodiments, the fugitive adhesive compositions further contain a tackifier. In some embodiments, the adhesion of the fugitive adhesive compositions of the invention is reduced to an unmeasurable value, or a zero value, between 1 and 60 minutes. In some embodiments, the fugitive adhesive bond time is up to 5 minutes as defined by the Fugitive Adhesion test. In some embodiments, the base polymer is a styrenic block copolymer (SBC); in other embodiments the base polymer is an ethylene copolymer. The fugitive adhesives are employed in a method of formation of assemblies that involves a) applying a hot melt fugitive adhesive of the invention to a substrate; b) arranging one or more containers, items, or components in a desired arrangement; and c) affixing the one or more containers, items, or components to the substrate to form an assembly. The fugitive adhesive of the invention acts to adhesively and cohesively hold the one or more containers, items, or components in the arrangement, wherein after a defined period of time called the “fugitive adhesive bond time” the containers, items, or components are adhesively released. The fugitive adhesive of the invention holds the one or more containers, items, or components in the desired configuration while one or more operations, for example handling, packaging, and/or one or more other industrially useful operations are carried out; the fugitive adhesive then releases the one or more containers, items, or components within the fugitive adhesive bond time, which corresponds to a period of time after the one or more operations are completed. Thus, in some embodiments, the assembly formed initially and prior to the elapse of the fugitive adhesive bond time is referred to herein as a “temporary assembly.” In some embodiments, notably where the one or more operations is employed to affix the one or more containers, items, or components in the arrangement formed in the temporary assembly after the fugitive adhesive bond time has elapsed, the assembly after completing the one or more operations is referred to as the “finished assembly.” The methods of the invention further contemplate the formation of a finished assembly, wherein the finished assembly is characterized by carrying out the one or more operations on the assembly, followed by loss of adhesion of the fugitive adhesive of the invention.

The fugitive adhesive of the invention is a hot melt adhesive which in some embodiments is applied to a substrate by applicators situated above a conveyor along which the substrate is traveling. Such an arrangement would be useful, for example, to form a temporary assembly during an industrial process such as packaging. The application temperature, depth of the adhesive bead applied, and application pattern of the adhesive should be consistent with the shape, topography, material, and temperature of both the substrate and the one or more containers, items, or components to be affixed thereto, as well as the one or more operations that will be carried out between the time the temporary assembly is formed and the one or more operations are carried out on the temporary assembly to form a finished assembly.

An important aspect of the fugitive adhesive compositions of the invention is the time between application of the composition to a substrate and the time of adhesive release to the substrate, referred to herein as the “fugitive adhesive bond time.” The fugitive adhesive bond time is determined, in turn, by the Fugitive Adhesive Bond Time test.

### Fugitive Adhesive Bond Time Test

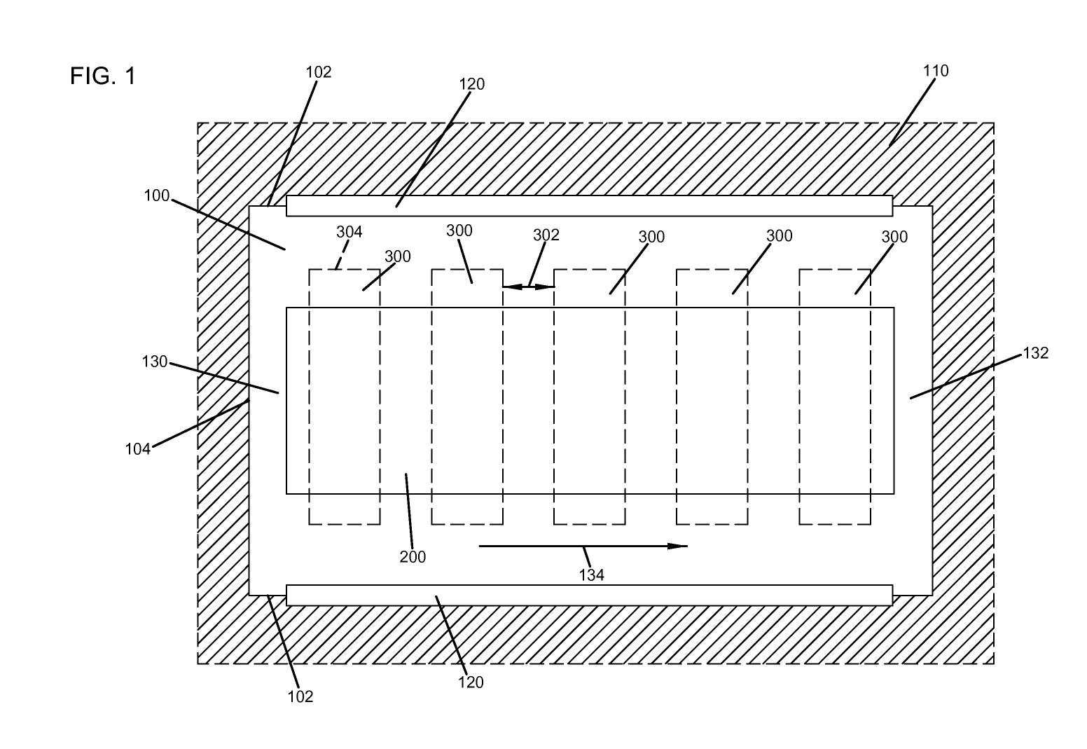

This is a detailed explanation of the test procedure used to measure the fugitive adhesive bond as reported in this disclosure and as claimed. Use of this test procedure will satisfy the test adhesive properties that are recited in the claims. The purpose of the test is to show that the bond is temporary in the sense that it can maintain a bond between an article and a paperboard substrate until such time the bonded article is sent to a next step in the packaging process.
1. Prepare substrates for testing.
   a. Referring to FIG. 1, fasten the long sides 102 of a piece of primary substrate 100, minimum sheet size 100 mm by 280 mm, to a substantially horizontal, flat, smooth surface 110 using two strips of pressure sensitive adhesive tape 120. As used herein, “primary substrate” refers to 56# high performance corrugated board stock obtained from Inland Container Corporation of Austin, Tex. or an equivalent board stock.
   b. Prepare 5 pieces of 0.254 mm (10 mil) polypropylene film (or equivalent polymeric 10 mil film) into strips 76 mm (3 in.) in length and 13 mm (0.5 in.) in width.
2. Prepare the test fugitive adhesive composition for testing.
   a. Add 300±10 g of a test fugitive adhesive composition to a 600 mL glass beaker and cover with a watch glass. Place the beaker containing the adhesive into the oven set to a temperature of 177° C. and heat until the adhesive is molten, approximately one hour.
   b. Concurrently heat an adhesive Precision Wet Film applicator (5.08 cm (2 inches) wide with a 0.254 mm (10 mil) gap; obtained from Precision Gauge and Tool Company of Dayton, Ohio) in the same oven for one hour.
   c. Remove the molten test fugitive adhesive composition from the oven, and using a thermocouple or a thermometer, verify that the temperature is at 177+/−5° C.
   d. Remove the adhesive applicator from the oven. Referring to FIG. 1, place the applicator in a first position 130 at a second side 104 of primary substrate 100. Place the applicator gap face down and in contact with primary substrate 100. Fill the applicator reservoir with the molten test fugitive adhesive composition.
3. Start the test (time=0).
   a. Referring again to FIG. 1, move the applicator containing the molten test fugitive adhesive composition from first position 130 in direction 134 to second position 132 in a single, smooth motion so as to deposit a single, uniform adhesive layer 200. The time to traverse the path from first position 130 to second position 132 is approximately 2 seconds.
   b. Immediately after applying adhesive layer 200 to primary substrate 100, place the polypropylene strips crosswise on the molten adhesive film as shown by positions 300, separating each strip by gap 302, wherein gap 302 is approximately 2 cm. Lightly press each strip into the adhesive film 200, using hand pressure, to assure complete adhesive wet-out. Using this method, apply all 5 polypropylene strips to positions 300 within 10 seconds of the application of adhesive film 200.
   c. Start a timer after the last polypropylene strip is applied.
4. Complete the test.
   a. After an interval of 5:00 minutes has elapsed on the timer, grasp edge 304 of a polypropylene strip and lift in a direction generally perpendicular to the plane of the surface of the primary substrate 100 to debond. Repeat for the remaining strips.
   b. Observe the area under the debonded polypropylene strips. Record observations of
      i. any tearing of the primary substrate, and
      ii. location of adhesive residue: all on the primary substrate, all on the polypropylene strip; or some residue on both the primary substrate and the polypropylene strip.
   c. If 4 of the 5 polypropylene strips debond without tearing of the primary substrate and without leaving adhesive residue on the primary substrate, a result of “pass” is recorded.
5. Repeat the test at a longer interval if less than 4 of the 5 bonds do not pass according to 4.c.
   a. Steps 1-4 are repeated using the same test fugitive adhesive composition and selecting an interval of more than 5:00 minutes in step 4.a.
   b. The test is repeated at longer selected intervals until a “pass” is determined according to 4.c. A result of “pass” is recorded for the selected interval.
6. A result of “pass” and the associated time interval means that the test fugitive adhesive bond time is less than or equal to the stated time interval.

The fugitive adhesive of the invention has a fugitive adhesive bond time of up to 60 minutes, or about 1 to 60 minutes, or about 5 to 30 minutes, or up to 10 minutes, or up to 5 minutes. During the fugitive adhesive bond time the elasticity of the semisolid hot melt fugitive adhesive has a fugitive bond that is sufficiently strong to permit aggressive movement of the temporary assembly without movement of the one or more containers, items, or components from their position on the substrate. As the fugitive adhesive begins to solidify, the adhesive bond weakens and within 60 minutes the one or more containers, items, or components substantially release from the substrate. In some embodiments, the fugitive adhesive releases from the one or more containers, items, or components, and remains on the substrate. In other embodiments, the fugitive adhesive releases from both the substrate and the one or more containers, items, or components.

The initial adhesive bonding strength of the fugitive adhesive of the invention in the temporary assembly, that is, between a substrate and one or more containers, items, or components, is controlled by varying the composition constituents and their amounts, the application temperature of the adhesive composition, and the depth of the adhesive bead applied. Generally the depth of the adhesive bead is about 0.1 cm to 0.5 cm, in some embodiments about 0.15 cm to 0.3 cm. A higher application temperature and deeper adhesive bead will increase the initial bonding strength and fugitive adhesive bond time of the fugitive adhesive of the invention, and a lower temperature and thinner adhesive strips or patches will decrease initial bonding strength and fugitive adhesive bond time. In embodiments, the hot melt adhesive is applied within a temperature range of 110° C. to 200° C., in some embodiments between 130° C. and 170° C.

The fugitive adhesive is applied most commonly in solid or intermittent strips or as patches. However, random patterns such as random spray patterns or spiral coatings are useful in some embodiments. In other embodiments, a solid sheet type coating is useful such that the adhesive covers an entire surface of the substrate. The timing between application of adhesive and affixing of the one or more containers, items, or components is generally between about 0.1 second and 20 seconds, in some embodiments between about 1 second and 10 seconds, or in some embodiments about 2 seconds to 3 seconds between application of adhesive on the substrate and affixing of the one or more containers, items, or components on substrate with the adhesive applied there between.

In some embodiments of the temporary assembly or the finished assembly, the temperature of the one or more containers, items, or components is elevated over typical indoor ambient temperatures (about 70° F., or 21° C.). In some embodiments, the contents of a container can be at an elevated temperature typically resulting from manufacture or process conditions. In some embodiments the elevated temperature is above 35° C., for example between about 35° C. and 85° C., or between about 50° C. and 65° C., depending on the item, container contents, or the processing steps used in making the item or container contents. For example, foods and beverages are often processed at elevated temperature for the purposes of cooking, pasteurization, blending, and packaging operations. As such temperatures in the range of about 35° C. and 85° C. are common. In high productivity processing and packaging lines, foodstuffs are commonly placed in a container at elevated temperatures and such containers are commonly introduced into a temporary assembly while warm. Such warm conditions make the initial bonding difficult and conventional fugitive adhesives do not adequately maintain the assembled package. For example, some dairy products such as yogurt are packaged while warm from the pasteurization process. In such embodiments, where the yogurt containers are assembled and packaged, the fugitive adhesive of the invention must still set up with the requisite fugitive adhesive bond time required to release the yogurt containers from a packaging substrate, such as a flat cardboard or chipboard base member, after packaging operations such as shrink wrapping are carried out on a temporary assembly of containers on a substrate. It is an advantage of the fugitive adhesives of the current invention that the fugitive adhesive bond time of the adhesive is suitable for such applications.

In some embodiments, the initial bond strength of the fugitive adhesives of the invention is characterized by a high adhesion strength compared to conventional hot melt adhesives after application between two substrates and prior to the passing of the fugitive adhesive bond time. “Initial bond” means the bond between the primary substrate and the polypropylene substrate in the Fugitive Adhesive Bond Time test, at any time after starting the test but prior to the passing of the fugitive adhesive bond time (i.e., the “pass” time interval). In such embodiments, the fugitive adhesive composition of the invention forms an initial adhesive bond between the primary substrate and the polyolefin substrate that is sufficient to tear the primary substrate when the polypropylene is debonded. The fugitive adhesives of the invention are further characterized by a very low or negligible “final adhesion,” which is defined herein as adhesion between a fugitive adhesive composition of the invention and an object after application of the composition, followed by the fugitive adhesive bond time period. The final adhesion of the fugitive adhesive of the invention is low relative to the initial bond strength, is not measurable, or is zero. In various embodiments, within about 5 to 60 minutes after application of a fugitive adhesive composition of the invention at a temperature of between about 110° C. to 200° C., the final adhesion to one or more containers, items, or components is low compared to the initial adhesion. In some embodiments employing the Fugitive Adhesive Bond Time test, the final adhesion is further characterized by adhesive failure between the fugitive adhesive composition and the polypropylene substrate. Thus, in such embodiments, no cohesive failure of the adhesive is observed after the fugitive adhesive bond time. In other such embodiments, adhesive failure is primarily observed to occur between the adhesive and the polypropylene substrate, wherein the polypropylene is cleanly released from the adhesive and the primary substrate with no observable residue. In some embodiments, adhesion between the adhesive and the one or more containers, items, or components cannot be measured after the fugitive adhesive bond time has passed because the adhesive has effectively delaminated from the one or more containers, items, or components. Thus, the final adhesion value is effectively zero in many embodiments of the invention. A final adhesion value also applies, in some embodiments of the invention, to the adhesive-substrate interface. Thus, the final substrate adhesion value or ultimate substrate adhesion value is defined as the adhesion between the fugitive adhesive of the invention and a substrate in the finished assembly, that is, after application of the adhesive to the substrate, the affixing of the one or more containers, items, or components, and the passage of a period of time defined as the fugitive adhesive bond time. In some such embodiments, the final substrate adhesion value is essentially zero.

The fugitive adhesives of the invention are designed to provide adhesion to a temporary assembly. During the fugitive adhesive bond time, one or more industrially useful operations are carried out, wherein it is desirable to hold one or more containers, items, or components in an assembled formation during the one or more operations, and it is also desirable to release them from the formation after completion of the one or more operations. In embodiments, such adhesives are useful in applications such as wrapping or shrink-wrapping items for shipping, stacking of one layer of containers, items, or components over another, moving an assembly around, including conveying on a conveyor belt, lifting and moving of the temporary assembly, and holding the temporary assembly at an angle from the horizontal plane; or a combination of one or more of these. In some embodiments, the fugitive adhesive of the invention acts to hold one or more containers, items, or components place while some other industrial operation takes place. For example, welding, curing, UV irradiation, painting, coating, metalizing, chemical treatments such as lithographic treatments, heat treatment, additional stacking, moving, etc. are all industrial processes that, in various embodiments, require one side or area of one or more containers, items, or components against a substrate while the remainder of the one or more containers, items, or components is painted, coated, treated, etc. followed by clean release of the one or more containers, items, or components from the substrate.

In somewhat more detail, the fugitive adhesive compositions of the invention employ a hydrogenated vegetable oil, also referred to as a vegetable based wax, at greater than 40% by weight of the composition, typically between 40% and 80% by weight of the composition. In some embodiments the amount of vegetable based wax is between about 40% and 60% by weight of the composition. In still other embodiments the amount of vegetable based wax is about 50% by weight of the composition. Particularly useful in various embodiments of the invention is soybean wax, prepared by hydrogenating soybean oil. Soybean wax is available, for example, from Marcus Oil and Chemical Corp. of Houston, Tex. Such waxes are also described in detail in Borsinger et al., U.S. Pat. No. 6,890,982. In embodiments, the vegetable-derived waxes usefully employed in the fugitive adhesive compositions of the present invention have melting points in the range of between about 50° C. to about 85° C. In some embodiments, the vegetable derived waxes have melting points in the range of between about 60° C. to about 75° C. In other embodiments, the vegetable derived waxes have melting points in the range of between about 65° C. to about 70° C. The melting point range of the wax is selected to provide a desired range of fugitive adhesive bond time of the fugitive adhesive compositions of the invention. “Fugitive adhesive bond time” as used herein means the time between dispensing of the adhesive onto a substrate in a molten state, where the substrate and surrounding environment is at a temperature that will cause the composition to solidify, become cloudy, crystallize, partially crystallize, or a combination thereof; and the point at which the adhesive substantially loses adhesion. While not wishing to be held to theory, we believe that when the compositions of the invention reach the cloud point of the composition or in some cases when there is sufficient crystallization of the vegetable wax, or otherwise sufficient solidification thereof, the fugitive adhesive composition loses adhesion with respect to the adherend. Use of a lower melting point wax will result in a longer setup time when employed in a composition of the invention, as it will take longer for the composition to reach the cloud point, or crystallization temperature, thereby causing loss of adhesion in turn.

Waxes prepared from hydrogenated plant oils, such as palm oil, soybean oil, sunflower oil, canola oil, castor oil, and the like are used as substitutes for petroleum derived or synthetic waxes in hot-melt fugitive adhesive compositions. The term “wax” is used to denote a broad class of organic ester and waxy compounds, which span a variety of chemical structures and display a broad range of melting temperatures. In the context of the present invention, “vegetable wax” means a vegetable or plant based oil that has been hydrogenated such that the iodine value is very low, for example less than about 30. Unlike conventional fugitive adhesive formulations, which employ petroleum derived or synthetic waxes, fugitive adhesive compositions of the invention include vegetable waxes, which are obtained from naturally derived, renewable biobased resources. Typically, the vegetable derived waxes have iodine values between 0 and 30, in some embodiments between 1 and 5, and melting points between about 45° C. and 100° C. (Mettler Drop Point), in some embodiments between about 65° C. and 85° C. In embodiments, the vegetable waxes employed in the compositions of the invention are composed of triglycerides whose fatty acids are predominantly stearic acid (C18). Useful soybean waxes are obtained commercially, for example, from Marcus Oil and Chemical Corp., Houston, Tex. under the trade designation Marcus Nat 155 or Nat 180. Palm oil wax is obtained from Custom Shortenings & Oils of Richmond, Va. under the trade designation Master Chef Stable Flake-P. Blends of two or more different vegetable or plant-based waxes are also useful in certain embodiments of the invention, in order to fine tune fugitive adhesive bond time, melt viscosity, and the like. Particularly useful in some fugitive adhesive compositions of the invention is Nat 155 from Marcus Oil and Chemical Corp. These vegetable waxes can also be used as food additives, and thus are nontoxic. The renewably derived vegetable waxes are used as an alternative to petroleum and synthetically derived waxes in the manufacture of fugitive adhesives usefully employed to temporarily bond paper, wood, glass, plastic and metal during a variety of manufacturing operations. Since the amount of vegetable wax employed in the fugitive adhesive compositions of the invention is at least 40% by weight of the composition, the fugitive adhesive compositions include at least 40% by weight of renewably sourced content, and as much as 80% by weight of renewably sourced content.

The base polymer is employed in the fugitive adhesive compositions of the invention in concentrations ranging from about 5% by weight to 50% by weight of the composition. In some embodiments, the polymer is employed at concentrations ranging from about 20% by weight to 40% by weight of the composition. In other embodiments, the polymer is employed at about 25% by weight to 35% by weight of the composition. In still other embodiments, the polymer is employed at about 30% by weight of the composition.

The base polymer employed in the fugitive adhesive compositions of the invention is, in some embodiments, selected from one or more copolymers of ethylene or copolymers of ethylene and vinyl acetate (ethylene-vinyl acetate, or “EVA”). The copolymer can be chosen from the group consisting of, but not limited to, ethylene acrylic acid copolymers, ethylene ethyl acrylate copolymers; ethylene methacrylic acid copolymers; ethylene vinyl acetate copolymers and terpolymers and other copolymers derived from ethylene, such as polyamides, polyethylene, polyethylene made with metallocene catalysts, polyesters, and polypropylenes. In embodiments, the polymer employed in the fugitive adhesive compositions of the invention is selected from one or more natural or synthetic rubbers, including styrene-isoprene and styrene-butadiene random and block copolymers. In still other embodiments the polymer employed in the fugitive adhesive compositions of the invention is selected from one or more polyvinyl acetate and vinyl acetate/unsaturated carboxylic acid copolymers, polyvinyl acetals, polyurethanes, and ethyl cellulose. Blends of any of these polymers in various ratios are also useful in one or more fugitive adhesive compositions of the invention. Particularly useful ethylenic base polymers employed in the fugitive adhesive compositions of the invention are the EVA copolymers. EVA copolymers useful in the fugitive adhesive compositions have between about 10% and 40% vinyl acetate content, in some embodiments between about 15% and 30% vinyl acetate content, or in other embodiments about 18% vinyl acetate content, or in still other embodiments about 28% vinyl acetate content. In embodiments, the EVA copolymers useful in the fugitive adhesive compositions have melt flow index of about 10 g per 10 minutes at 190° C. of about 10 g/10 min to 100 g/10 min. In some embodiments, the EVA copolymers useful in the fugitive adhesive compositions have melt flow index in the range of about 10 g/10 min to 50 g/10 min. In other embodiments, the EVA copolymers useful in the fugitive adhesive compositions have melt flow index in the range of about 20 g/10 min to 30 g/10 min. In still other embodiments, the EVA copolymers useful in the fugitive adhesive compositions have melt flow index of about 30 g/10 min. One particularly useful EVA copolymer is Escorene™ Ultra UL 7740, sold by ExxonMobil Corporation of Irving, Tex.

Another category of useful polymers employed in the fugitive adhesive compositions of the invention are block copolymers. Block copolymers useful include ABA triblock structures, AB diblock structures, (A-B)ₙ radial block polymers, as well as branched and grafted materials. The B block is typically isoprene, butadiene, hydrogenated butadiene, hydrogenated isoprene, etc. Commercial embodiments include the KRATON® block polymer materials (Kraton Polymers U.S. LLC of Houston, Tex.), SEPTON® (SEEPS) polymers (Kuraray Specialities Europe GmbH of Frankfurt, Germany), EUROPRENE® polymers, for example EUROPRENE® Sol T block polymers (Polimeri Europa of Milan, Italy), and VECTOR® block polymers (Dexco Polymers LP, of Houston, Tex.). The A block is either styrene or vinyl. The A block content of the polymer ranges from 0.1 wt-% to about 50 wt-% of the polymer. Typically, the aromatic A block concentration ranges from about 5 wt-% to about 45 wt-% based on the polymer. The styrene content can be less than about 25 wt-%, more preferably less than about 20 wt-% and most preferably from about 5 wt-% to about 15 wt-% styrene with respect to the total weight of the block copolymer. Particularly useful in compositions of the invention are styrene-butadiene-styrene triblock copolymers (“SBS”). In embodiments, SBS copolymers useful in the fugitive adhesive compositions are substantially linear, substantially triblock copolymers with less than 2% by weight of diblock content. SBS copolymers useful in the fugitive adhesive compositions have styrene content in the range of about 20% by weight to 60% by weight of the copolymer. In some embodiments, the SBS copolymer has styrene content in the range of about 30% by weight to 50% by weight of the copolymer. In other embodiments, the SBS copolymer has styrene content in the range of about 40% by weight to 45% by weight of the copolymer. SBS copolymers useful in the fugitive adhesive compositions have melt flow index in the range of about 1 g per 10 minutes at 200° C. (1 g/10 min) to 100 g/10 min. In embodiments, SBS copolymers useful in the fugitive adhesive compositions have melt flow index in the range of about 10 g/10 min to 50 g/10 min. In other embodiments, SBS copolymers useful in the fugitive adhesive compositions have melt flow index in the range of about 20 g/10 min to 40 g/10 min. In still other embodiments, SBS copolymers useful in the fugitive adhesive compositions have melt flow index in the range of about 20 g/10 min to 30 g/10 min. One example of a useful SBS copolymer in the fugitive adhesive compositions of the invention is VECTOR® 6241A, sold by Dexco Polymers LP.

In some embodiments, the fugitive adhesive compositions of the invention do not employ tackifiers. In other embodiments, tackifiers are employed in the fugitive adhesive compositions of the invention to provide improved wetting of the melted composition, improve initial adhesive tack and to lower viscosity of the composition in the molten state. In the fugitive adhesive compositions of the invention where tackifier is employed, the tackifer improves adhesive tack for the joining of objects during the adhesive period and prior to solidification and concomitant loss of adhesion. Effective tackifiers in some of the fugitive adhesives of the invention include glycerol and pentaerythritol esters of natural and chemically modified rosins; naturally occurring and chemically modified resins, such as wood rosin, gum rosin, tall oil rosin, distilled rosin, and rosins modified by processes such as polymerization, hydrogenation, maleation and dimerization; polyterpene resins; modified terpene resins, such as chlorinated terphenyl resins and phenolic-modified terpene resins; and aliphatic and cycloaliphatic petroleum hydrocarbon resins, such as those resulting from polymerization of olefin and diolefin monomers.

In embodiments, the tackifiers employed in some of the fugitive adhesive compositions of the invention are characterized by chemical type and further by parameters such as their softening points, melt viscosities, or acid number. In embodiments, a tackifier is selected from among the variety of tackifier chemical structure types, as described above but not limited thereto. In embodiments, the tackifier is selected from tackifiers characterized by softening point in the range of about 80° C. to 150° C., in other embodiments in the range of about 90° to 120° C. In embodiments, the tackifier is selected from tackifiers characterized by a range of acid numbers, such as acid numbers between 1 and 100, or in some embodiments between 1 and 25, or in still other embodiments between 1 and 10. In embodiments, the tackifier is used in amounts ranging from about 1% by weight to about 40% by weight. In other embodiments, the tackifier is used in amounts of about 2% by weight to 30% by weight. In still other embodiments, the tackifier is used in amounts of about 3% to 25% by weight in the fugitive adhesive compositions of the invention.

In the composition of the present invention, one example of a useful tackifying agent is ESCOREZ® 5400, available from the ExxonMobil Chemical Company of Houston, Tex. Another example of a useful tackifying agent is SYLVALITE® RE 100L, a rosin ester available from Arizona Chemical Company of Jacksonville, Fla. Other commercially available polymerized rosins may be obtained from Arizona Chemical Company under the trade designations “SYLVATAC 295, RX, R85, 95, and 140,” respectively. Additionally, Eastman Chemical Company of Kingsport, Tenn. produces a suitable dimerized rosin under the trade designation “DYMEREX®.” Commercially suitable partially hydrogenated rosins may be secured from Eastman Chemical Company under the trade designation “FORAL® AX” or from the Florachem Corporation of Jacksonville, Fla. under the trade designation “FLORAREZ™” Finally, partial ester of dibasic modified tall oil rosins may be secured from Arizona Chemical Company under the trade designation “SYLVATAC® 203.”

Other tackifying resins useful in various embodiments of the compositions of the invention include polyterpene resins having a softening point, as determined by ASTM method E28-58T, of from about 20° C. to 140° C., generally resulting from the polymerization of terpene hydrocarbons, such as the monoterpene known as pinene, in the presence of Friedel-Crafts catalysts at moderately low temperatures. Also useful are the hydrogenated polyterpene resins; copolymers and terpolymers of natural terpenes, e.g. styrene/terpene, a-methyl styrene/terpene and vinyl toluene/terpene; phenolic-modified terpene resins such as, for example, the resin product resulting from the condensation, in an acidic medium, of a terpene and a phenol; aliphatic petroleum hydrocarbon resins having Ring and Ball softening points of from about 10° C. to 140° C., the latter resins resulting from the polymerization of monomers consisting primarily of olefins and diolefins; also included are the hydrogenated aliphatic petroleum hydrocarbon resins; examples of such commercially available resins based on a C5-olefin fraction of this type are “WINGTACK® 95” and “WINGTACK® 115” tackifying resins sold by Cray Valley of Paris, France; aromatic petroleum hydrocarbons and the hydrogenated derivatives thereof; aliphatic/aromatic petroleum derived hydrocarbons and the hydrogenated derivatives thereof.

In some embodiments of the compositions of the invention, mixtures of two or more of the above described tackifying resins are employed to optimize the melt viscosity, initial tack, or other physical properties of the fugitive adhesives of the invention.

In some embodiments, the fugitive adhesive compositions of the invention include a petroleum based paraffin wax. Paraffin waxes are hydrocarbon mixtures with the general formula CnH2n+2 wherein 20≦n≦40. Straight chain saturated hydrocarbons are the predominant functionality, though there are typically small amounts of unsaturated and/or branched hydrocarbons. In some embodiments, paraffin wax is added to the fugitive adhesive compositions of the invention to adjust the set up time of the composition from the melt temperature employed during application, and thereby control the time between application and loss of adhesion. Paraffin waxes differ from one another chiefly in melting point, which in turn is attributable to differences in the distribution of hydrocarbons of various formula weights. Most paraffin grades cover a relatively narrow melting point range of a few degrees Fahrenheit; such waxes are particularly useful in conjunction with the fugitive adhesive compositions of the invention, because the utility of paraffin is to make fine adjustments to the set up temperature and time of the formulation; the set up time is, in turn, affected by the melting range of the paraffin. In embodiments where paraffin wax is employed in the fugitive adhesive compositions of the invention, typically the amount used is between about 1% by weight to 20% by weight, in some embodiments about 3% to 10% by weight, in other embodiments about 4% to 7% by weight. In embodiments, a minimum amount of paraffin is employed so that the vegetable based content of the fugitive adhesive compositions of the invention is maximized. The fugitive adhesive formulations of the invention are not particularly limited as to the use of paraffin wax nor as to the melting temperature range of paraffin wax that is useful; one of skill will appreciate that for various formulations, the melting range that is useful is determined by the type and amount of the other composition components and the paraffin is used to fine tune the set up time of the fugitive adhesive composition from the melt. In some embodiments, the fugitive adhesive formulations of the invention employ paraffin having a melting point in the range of about 100° C. to 200° C. In other embodiments, the fugitive adhesive formulations of the invention employ paraffin having a melting point in the range of about 120° C. to 180° C. In still other embodiments, the fugitive adhesive formulations of the invention employ paraffin having a melting point in the range of about 140° C. to 160° C.

In some embodiments of the fugitive adhesive formulations of the invention, a useful type of petroleum based wax is a maleated wax. In embodiments, Epolene® waxes from Westlake Chemical Corporation of Houston, Tex. Epolene® C-18 wax is one particularly useful maleated wax. Maleated waxes are compatible with a wide range of formulation constituents, and therefore in some embodiments do not undergo phase separation in the fugitive adhesive compositions of the invention either when molten or when approaching a solid state. Additionally, in some embodiments, maleated wax causes the fugitive adhesive composition of the invention to preferentially remain on one surface and release cleanly from a second surface after the fugitive adhesive bond time has elapsed. For example, in packaging applications, where a polyolefin container is adhered to a paperboard or cardboard substrate, the presence of maleated wax in some embodiments causes the fugitive adhesive composition to preferentially remain on the paperboard or cardboard substrate and remove cleanly without visible residue from the polyolefin container after the fugitive adhesive bond time has elapsed and the packaged assembly is disassembled.

The fugitive adhesive compositions of the invention further employ other optional additives to modify various properties of the compositions in various embodiments thereof. For example, antioxidants and free radical scavengers are commonly employed in conventional hot melt adhesive compositions in order to increase thermal stability of the compositions; this is because during use the compositions are often held at high temperatures for extended periods of time. Generally, hot melt adhesive compositions are heated to between about 110° C. and 200° C., in some embodiments between about 130° C. and 170° C., in still other embodiments between about 150° and 175° C., prior to application in order to reduce viscosity of the composition. The composition must be stable at these temperatures to allow for extended periods as a molten product prior to application. In embodiments, antioxidants such as hindered phenols are employed. Representative hindered phenols include 1,3,5-trimethyl-2,4,6-tris(3-5-di-tert-butyl-4-hydroxybenzyl)benzene; pentaerythritol tetrakis-3(3,5-di-tert-butyl-4-hydroxyphenyl)propionate; n-octadecyl-3(3,5-ditert-butyl-4-hydroxyphenyl)propionate; 4,4′-methylenebis(4-methyl-6-tert butylphenol); 4,4′-thiobis(6-tert-butyl-o-cresol); 2,6-di-tert-butylphenol; 6-(4-hydroxyphenoxy)-2,4-bis(n-ocytlthio)-1,3,5-triazine; 2,4,6-tris(4-hydroxy-3,5-di-tert-butyl-phenoxy)-1,3,5-triazine; di-n-octadecyl-3,5-di-tert-butyl-4-hydroxybenzylphosphonate; 2-(n-octylthio)ethyl-3,5-di-tert-butyl-4-hydroxybenzoate; and sorbitol hexa-(3,3,5-di-tert-butyl-4-hydroxy-phenyl)propionate. One example of a useful hindered phenol is IRGANOX® 1010 (pentaerythritol tetrakis(3-(3,5-di-tert-butyl-4-hydroxyphenyl)propionate), available from BASF Corp. of Florham Park, N.J.), and free radical scavengers such as, but not limited to, butylated hydroxytoluene or “BHT”, and butylated hydroxyanisole or “BHA”, available from multiple vendors. Any of these are advantageously added to the fugitive adhesive compositions of the invention to further enhance thermal stability. These free radical scavengers and antioxidants are generally added to the fugitive adhesive compositions of the invention in amounts ranging from about 0.01% to 5% by weight of the composition. In some embodiments stabilizers and antioxidants are employed in the fugitive adhesive compositions of the invention in amounts ranging from about 0.01% to 1% by weight of the composition.

Other types and amounts of additives usefully employed with the fugitive adhesives of the invention are not particularly limited and include, in various embodiments, colorants (dyes or pigments), bleaches, plasticizers, dispersants (cationic, anionic, zwitterionic, or nonionic surfactants), solvents, and fillers. A release agent may be used as an optional component in the non-permanent adhesive formulation of the invention. A release agent is useful in some embodiments of the compositions of the invention where very high release, very low initial adhesion, or both is required in the particular method of use that is envisioned. Release agents include, for example, amide waxes and silicone oils. One example of a useful release agent is the amide wax KENAMIDE® E from Chemtura, Inc. of Philadelphia, Pa. In some embodiments, the release agent is used at concentrations ranging from 0.001% to 5% by weight of the fugitive adhesive compositions of the invention. In addition, small amounts of additional tackifiers and/or waxes such as microcrystalline waxes, hydrogenated castor oil and vinyl acetate modified synthetic waxes may also be incorporated in minor amounts, i.e., up to about 10 weight percent by weight, into the formulations of the present invention. Additionally, hydrocarbon oils, especially naphthenic or paraffinic process oils, may also be employed herein as the wax diluent. One or more of additives in combination are used in some embodiments of the fugitive adhesive compositions of the invention. The range of concentration of these additives in the compositions is not particularly limited. However, in many embodiments the amount of any one additive is usually about 10% or less by weight of the composition, in many embodiments about 5% or less by weight of the composition.

Additional waxes or oils optionally useful in the composition of the present invention are present, in some embodiments, either alone or in any desired blend in amounts of about 0% to about 50% by weight, preferably from about 5% to about 40% by weight, and most preferably from about 10% to about 30% by weight, and are used to reduce the melt viscosity and surface tack of the hot melt construction adhesives without appreciably decreasing their adhesive bonding characteristics. These waxes also are used to reduce the fugitive adhesive bond time of the composition without affecting the temperature performance. Among the useful waxes are: low molecular weight, that is, 600-6000 Mn polyethylene having a hardness value, as determined by ASTM method D-1321, of from about 0.1 to 120 and ASTM softening points of from about 150° to 250° F.; (2) petroleum waxes such as paraffin wax having a melting point of from about 130° to 170° F. and microcrystalline wax having a melting point of from about 135° to 200° F., the latter melting points being determined by ASTM method D127-60; amorphous polypropylene having a Ring and Ball softening point of from about 120° to 160° C.; synthetic waxes made by polymerizing carbon monoxide and hydrogen such as Fischer-Tropsch wax; and polyolefin waxes. As used herein, the term “polyolefin wax” refers to those polymeric or long-chain entities comprised of olefinic monomer units. The materials which are preferred to use in the compositions of the present invention have a Ring and Ball softening point of 200° F. to 350° F.

Other useful substances include hydrogenated animal, fish and vegetable fats and oils such as hydrogenated tallow, lard, soya oil, cottonseed oil, castor oil, menhadin oil, cod liver oil, etc., and which are solid at ambient temperature by virtue of their being hydrogenated, have also been found to be useful with respect to functioning as a wax diluent equivalent. These hydrogenated materials are often referred to in the adhesives industry as “animal or vegetable waxes.” Various plasticizing or extending oils may also by present in the composition in amounts of 5% to about 30%, preferably 5 to 25%, by weight in order to provide wetting action and/or viscosity control. Even higher levels may be used in cases where block copolymer containing hydrogenated mid-block are employed as the adhesive base polymer. The above broadly includes not only the usual plasticizing oils but also contemplates the use of olefin oligomers and low molecular weight polymers as well as vegetable and animal oil and their derivatives. The petroleum derived oils which may be employed are relatively high boiling materials containing only a minor proportion of aromatic hydrocarbons (preferably less than 30% and, more particularly, less than 15% by weight of the oil). Alternatively, the oil may be totally non-aromatic. The oligomers may be polypropylenes, polybutenes, hydrogenated polyisoprene, hydrogenated polybutadiene, or the like having average molecular weights between about 350 and about 10,000. Vegetable and animal oils include glycerol esters of the usual fatty acids and polymerization products thereof.

Procedures and methods for formulating hot melt adhesive compositions are well known in the art. Any of these procedures may be used to blend and prepare the fugitive adhesive compositions of the invention. Descriptions of those procedures and methods may be reviewed, for example, in Handbook of Adhesives, by Irving Skeist, Van Nostrand Reinhold International; 3rd edition (1990). Melt viscosity is another important parameter for these fugitive adhesive compositions of the invention. Acceptable viscosities typically range from 300-5,000 cps at 177° C. for non-permanently bonding hot melt adhesives. The composition components recited above, and the methods employed to make the compositions, are selected not only to impart the fugitive adhesive properties defined above, but also to provide optimum melt viscosity to enable the use of standard hot melt adhesive application equipment employed in the industry.

In somewhat more detail regarding the articles formed using the fugitive adhesive compositions of the invention, the articles are assemblies or finished assemblies. As defined herein, an “assembly” means either a finished assembly or a temporary assembly, wherein a temporary assembly is formed by applying a fugitive adhesive of the invention to a substrate; arranging one or more containers, items, or components in a desired arrangement, and affixing the one or more containers, items, or components to the substrate to form the assembly. A “finished assembly” is formed by carrying out one or more additional operations on the temporary assembly, the finished assembly being characterized by having one or more means to hold the assembly in the desired arrangement after the fugitive adhesive of the invention loses its adhesive properties. An assembly of the invention includes a) one or more containers, items, or components; b) one or more substrates; and c) one or more areas having a fugitive adhesive composition disposed between the one or more containers, items, or components, and the one or more substrates. A finished assembly further includes one or more means to hold the assembly in a desired arrangement after the fugitive adhesive of the invention loses its adhesive properties.

In some embodiments of the assembly or the final assembly of the invention, a container, item, or component has at least one substantially flat portion such that the container, item, or component would remain effectively stable or metastable when disposed against a horizontal surface. A substantially flat portion of the container, item, or component that contacts the substrate, the fugitive adhesive of the invention, or both is called the “footprint” of the container, item, or component. As used herein, “container” means anything that contains or can contain something, as a carton, box, crate, bottle, or can. The size, form, or shape of the container is not particularly limited within the scope of the invention. Examples of containers include containers for comestibles such as soda cans, soup cans, plastic yogurt containers, milk or juice cartons or jugs, cereal or snack boxes, punnets or cartons for fresh produce, plastic wrapped solid foods such as cheese, and the like. In some embodiments, the container is a housing for electronics, car components, and the like. Many different types of containers are suitably employed to form the assemblies of the invention. The material from which the container is formed is not particularly limited within the scope of the invention. Common container materials include cardboard, paper, wood, aluminum, tin, steel, thermoplastics such as polyesters such as polyethylene terephthalate, polyamides such as nylons, or polypropylene, thermoset polymers, glass, ceramics, and blends or layered composites thereof and include, in some embodiments, coatings of wax or other materials, colorants, preservatives, stabilizers, processing lubricants, and the like. As used herein, an “item” is a general term meaning movable effects or property, articles of trade, wares, merchandise, or any other similar meaning assigned to discrete and separate articles or objects. Food items, appliances, electronic goods, clothing, jewelry, and the like are some examples of items. As used herein, “components” means a discrete article or object that is a constituent part, element, or ingredient of an item as that term is defined herein. In some embodiments, the fugitive adhesives of the invention are useful for assembling one or more components wherein the finished assembly is an item. Examples of components include disk magnets to be included as a component in an item, round buttons that are components of clothing, ceramic disk capacitor bodies, “silver can” type capacitors for circuit boards, round button components for electronic items, transparent glass or plastic panels for windows, electronic displays, mirrors or windshields for cars, or other component-type objects are easily envisioned by one of skill.

The substrate is provided for the purpose of disposing the one or more containers, items, or components thereon. The fugitive adhesive of the invention is disposed between the substrate and the one or more containers, items, or components to affix the one or more containers, items, or components thereto during the fugitive adhesive bond time. In embodiments, the substrate is a flat base member. In embodiments, the substrate is a box, a tray, a pallet, or a portion thereof. In embodiments, the substrate is composed of cardboard, corrugated cardboard, paper, paperboard, woven or nonwoven synthetic or natural fiber, rigid or flexible thermoplastic or thermoset sheeting, metal sheets, foam sheets, and the like; or combinations of one or more layers thereof, composites thereof, blends thereof, or multilayer substrates composed of one or more thereof. In some embodiments, the substrate is discardable, compostable, or recyclable. In some such embodiments, the substrate layer is biomass based. In some such embodiments the substrate is formed from recycled materials such as post-consumer paper, cardboard, or plastic material. In some embodiments the biomass based material is a synthetic polymer such as poly(lactic acid); in other embodiments the biomass based material is a natural material such as cellulose based paper or cardboard.

In some embodiments, the substrate is an additional one or more additional containers, items, or components; in such embodiments, the fugitive adhesive compositions of the invention are disposed between two or more containers, items, or components and functions to hold the two or more containers, items, or components in a desired arrangement with respect to one another in an assembly. The two or more containers, items, or components are the same or different in various embodiments.

In some embodiments, the substrate is a temporary substrate, wherein the substrate is part of the temporary assembly but not the finished assembly. In some such embodiments, the temporary substrate is a sheet or tray, wherein the sheet or tray is removed from the assembly after one or more operations are carried out on the assembly to form the final assembly and after the fugitive adhesive bond time period, wherein the fugitive adhesive of the invention has lost adhesive strength. In other embodiments, the temporary substrate is a belt or other continuous substrate, wherein the belt conveys the temporary assembly during the one or more operations to form the final assembly, and the final assembly is removed from the belt after the one or more operations are completed and the fugitive adhesive of the invention has lost adhesive strength.

In the temporary assembly, the fugitive adhesive composition of the invention bonds the one or more containers, items, or components to one or more substrates with sufficient adhesive and cohesive force to withstand the one or more operations that are carried out on the temporary assembly during the fugitive adhesive bond time. In some embodiments of the invention, the completion of the one or more operations results in a finished assembly. A finished assembly further includes one or more means to hold the assembly in the desired arrangement after the fugitive adhesive of the invention loses its adhesive properties, and is further characterized in that the fugitive adhesive of the invention no longer provides adhesion; that is, the finished assemblies of the invention are formed at the end of the fugitive adhesive bond time of the adhesive composition as applied to the temporary assembly. In the final assembly, the fugitive adhesive composition of the invention releases cleanly from the one or more containers, items, or components such that no residue of the adhesive is observable on the one or more containers, items, or components. In some embodiments of the final assembly, the fugitive adhesive compositions of the invention have an unmeasurable level of adhesion, or no adhesion to the one or more containers, items, or components. In some embodiments of the final assembly, the fugitive adhesive compositions of the invention have an unmeasurable level of adhesion, or no adhesion, to the substrate upon which the adhesive composition is disposed. In some embodiments the finished assembly further contains one or more additional items such as clear or opaque plastic sheeting or wrapping, elastic bands, wire or plastic ties, chipboard, cardboard, paper, paperboard, rigid plastic sheets or members, cloth, clips, hook and loop fasteners, nonwoven sheets, foam sheets, formed foam members, foam peanuts, desiccants, and the like, or combinations thereof. In some embodiments, the one or more additional items contain printed messages or images. In some such embodiments the one or more additional items are discardable, compostable, reusable, or recyclable. In some such embodiments, the one or more additional items are biomass based. In some embodiments, dividers made of chipboard, cardboard, paper, paperboard, rigid plastic sheets or members, or cloth are further added to the assembly. Such dividers act to maintain long term separation between two or more containers, items, or components. For example, in embodiments where the one or more containers, items, or components are made of glass or have glass components thereof, a divider is useful to maintain long-term separation of the glass surfaces to prevent scratching or breaking thereof. In some embodiments, additional protective materials such as foam peanuts or other foam members are applied between two or more containers, items, or components to prevent contact between them in the finished assembly. One of the advantages of the fugitive adhesive of the invention is that it holds two or more containers, items, or components apart during addition of the dividers or additional protective materials, thereby allowing for ease of addition and preventing undue breakage or scratching during formation of the finished assembly.

In some embodiments, the finished assembly contains two or more layers of the one or more containers, items, or components. In some such embodiments, the finished assembly further includes two or more substrates or additional items as described above, or a combination of one or more thereof. In some such embodiments, the finished assembly further includes two or more layers or areas of the fugitive adhesive composition. In some such embodiments, one or more substrates is an additional layer of the one or more containers, items, or components. In some such embodiments, the layers of containers, items, or components are disposed substantially vertically with respect to each other. In other embodiments the layers of containers, items, or components are disposed substantially horizontally to one another. In some such embodiments the one or more layers of containers, items, or components are packaged for sale in plastic, paper, paperboard, or metal containers or containers that are a combination of one or more thereof. In some such embodiments the packaging for sale includes printed messages or images, or one or more labels containing printed messages or images.

The present invention contemplates a method of forming an assembly of one or more containers, items, or components in a desired configuration by assembling the one or more containers, items, or components in a desired configuration; and applying the fugitive adhesive of the invention to adhesively and cohesively hold the one or more containers, items, or components in the arrangement, wherein after a defined period of time the containers, items, or components are adhesively released. The fugitive adhesive of the invention stabilizes the one or more containers, items, or components in the desired configuration while one or more operations, for example handling, packaging, and the like is carried out; the fugitive adhesive then releases the one or more containers, items, or components soon after the one or more operations are completed. The method includes a) applying a molten fugitive adhesive of the invention to a substrate; b) arranging one or more containers, items, or components in a desired arrangement; c) affixing the one or more containers, items, or components to the substrate to form an assembly; and d) carrying out one or more additional operations on the assembly. In some embodiments, the one or more additional operations results in the formation of a finished assembly. Finished assemblies arise where the one or more operations act on the assembly to maintain the spatial arrangement of the one or more containers, items, or components after the fugitive adhesive bond time of the adhesive.

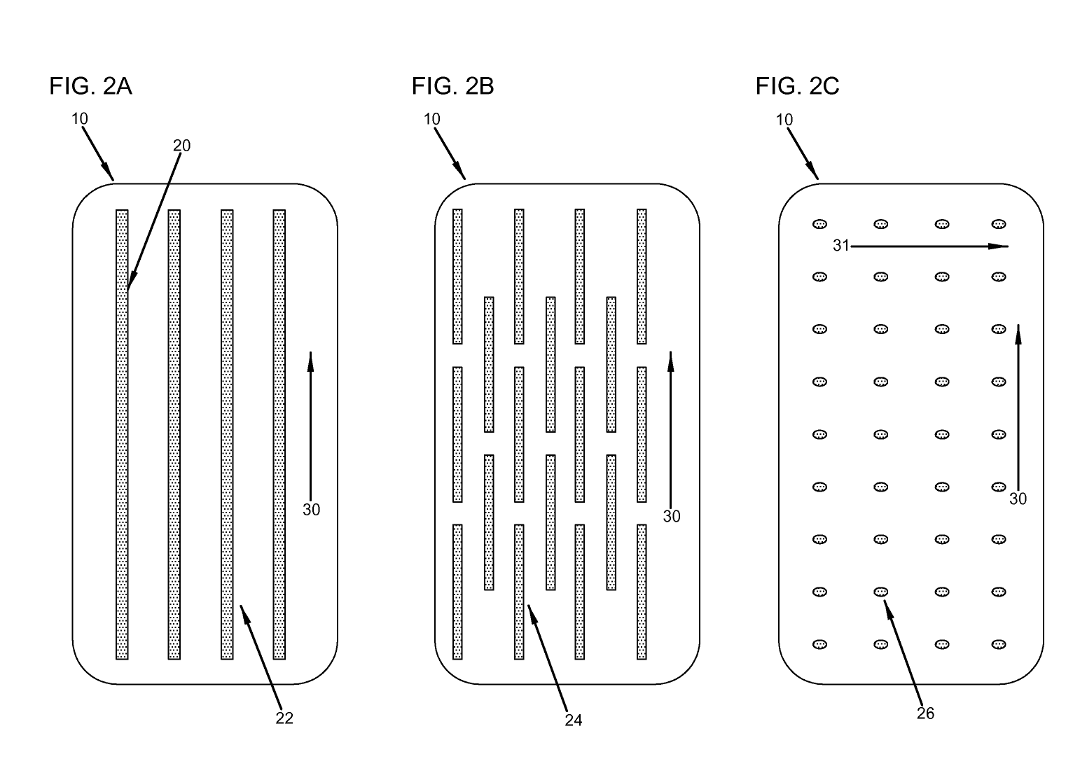

Representative methods of the invention are illustrated in FIG. 2-5. FIG. 2A-C shows three examples of patterns of a fugitive adhesive of the invention applied to a substrate prior to affixing one or more containers, items, or components to form a temporary assembly. It will be understood that the three examples illustrated in FIG. 2A-C are only representative of some of the many configurations of substrate-adhesive combinations possible employing the methods and assemblies of the invention and do not in any way limit the scope of possible configurations and methods of making such configurations. Referring to FIG. 2A-C, substrates 10 have a fugitive adhesive of the invention 20 applied thereon. Adhesive 20 is applied as solid strips 22, intermittent strips 24, or patches 26. Intermittent strips 24 are applied in a staggered pattern. Using standard hot melt adhesive equipment known to those of skill, solid strips 22 of adhesive 20 are easily applied to substrate 10 by conveying substrate 10 in machine direction 30, such that substrate 10 passes under hot melt adhesive application nozzles dispensing a bead of adhesive 20. Likewise, intermittent adhesive strips 24 are easily applied to substrate 10 by conveying substrate 10 in machine direction 30, such that substrate 10 passes under hot melt adhesive application nozzles dispensing an intermittent bead of adhesive 20. Patches 26 of adhesive 20 are applied in similar fashion as intermittent strips 24, except that the intermittent bead of adhesive 20 is dispensing adhesive at a smaller percent of time to form patches 26 than to form intermittent strips 24; or alternatively the substrate 10 is conveyed at a slower rate past adhesive dispensing nozzles. Additionally, patches 26 need not be dispensed by conveying substrate 10 in machine direction 30; an alternative machine direction 31 is also employed in some embodiments of the invention. Any conveyance of substrate 10 under adhesive dispensing nozzles can result in adhesive 20 dispensed as patches 26. Other embodiments, such as randomly placed (no repeating pattern) patches of adhesive 20 could be envisioned by one of skill, for example by a random or spiral spray of the adhesive 20.

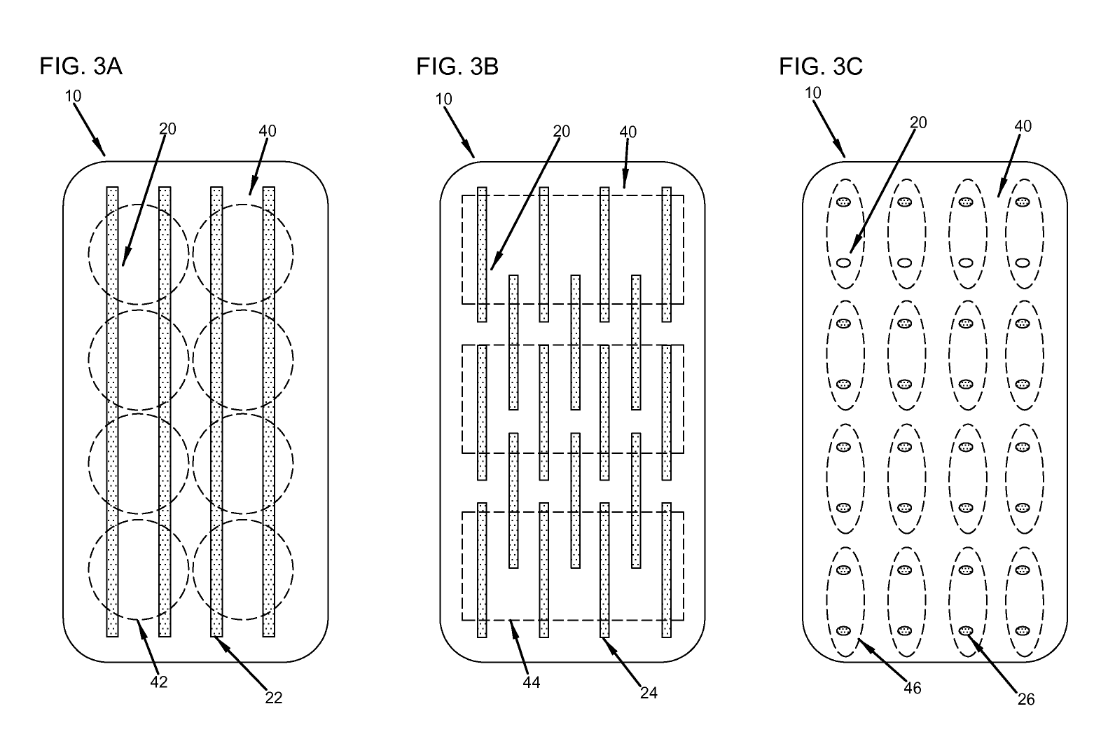

FIG. 3A-C illustrates three representative examples of patterns of a fugitive adhesive of the invention applied to a substrate prior to affixing one or more containers, items, or components to form a temporary assembly as depicted in FIG. 2A-C, and further shows the areas where the one or more containers, items, or components will be affixed after the adhesive is applied to the substrate. It will be understood that the examples shown in FIG. 3A-C are only representative of some of the many configurations of substrate-adhesive-container/item/component combinations possible employing the methods and assemblies of the invention and do not in any way limit the scope of possible configurations and methods of making such configurations. Referring to FIG. 3A-C, substrates 10 have the fugitive adhesive of the invention 20 applied thereon as solid strips 22, intermittent strips 24, or patches 26 as shown in FIG. 2A-C. Substrates 10 further show footprint areas 40 where one or more containers, items, or components may be suitably arranged in a desired arrangement on top of applied adhesives 22, 24, or 26 so as to affix the one or more containers, items, or components to substrate 10 to form a temporary assembly of the invention. One or more containers, items, or components having a round footprint 42 are shown as potentially arranged on substrate 10 and on top of adhesive 20 by affixing the one or more containers, items, or components 42 to solid adhesive strips 22 to form a temporary assembly. Examples of containers, items, or components having a round footprint 42 include aluminum soup cans, glass or plastic soda pop bottles, plastic yogurt containers, coin batteries, disk magnets sold alone or to be included as a component in an item, compact disks, round buttons that are components of clothing, ceramic disk capacitor bodies, “silver can” type capacitors for circuit boards, round button components for electronic items, or other objects easily envisioned by one of skill. One or more containers, items, or components having a rectangular footprint 44 are shown as potentially arranged on substrate 10 and on top of adhesive 20 by affixing the one or more containers, items, or components 44 to intermittent adhesive strips 24 to form a temporary assembly. Examples of containers, items, or components having a rectangular footprint 44 include box type containers for foods such as cereal, crackers or other snacks, cake mixes, and the like, juice or milk cartons, box type containers for electronics, appliances, tools, and the like, car components such as car batteries, pictures or posters, computer and other electronic housings, electronic components such as silicon chips, circuit boards, housings, and the like, stacks of sandpaper, folded paper bags, or flattened boxes and the like, or other objects easily envisioned by one of skill. One or more containers, items, or components having an oval footprint 46 are shown as potentially arranged on substrate 10 and on top of adhesive 20 by affixing the one or more containers, items, or components having oval footprint 46 to adhesive patches 26 to form a temporary assembly. Examples of containers, items, or components having an oval footprint 46 include plastic bottles or jars for personal care formulations such as lotions, shampoos, cosmetics, and the like, transparent glass or plastic components for display portions of electronics, or other objects easily envisioned by one of skill.

In some such embodiments, arranging includes arranging one or more containers, items, or components spatially in relation to one or more additional containers, items, or components. In embodiments, the arranging includes arranging the one or more containers, items, or components spatially in relation to the substrate. In other embodiments, the arranging includes arranging the one or more containers, items, or components spatially in relation both to one or more additional containers, items, or components, and to the substrate. In embodiments, the affixing includes contacting the one or more containers, items, or components to the fugitive adhesive disposed on the substrate. In some embodiments, the affixing includes application of pressure to maximize the contact area between the one or more containers, items, or components and the fugitive adhesive of the invention. Assembling and affixing the one or more containers, items, or components to the fugitive adhesive of the invention, as disposed on the substrate, constitutes formation of a temporary assembly of the invention.

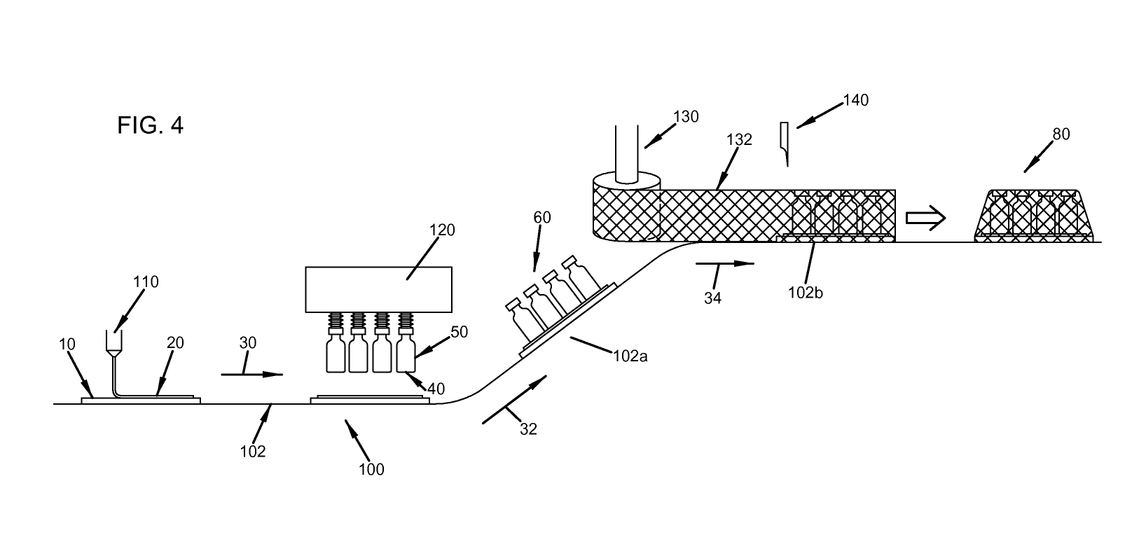

In embodiments, formation of the temporary assembly is followed by formation of a final assembly. FIG. 4 shows one embodiment of a method of forming a finished assembly of the invention. Referring to FIG. 4, an automated packaging system 100 is shown, which includes a conveyor belt 102, adhesive application nozzle 110, container arranging and affixing mechanism 120, plastic wrap applicator 130, and knife 140. A substrate 10 is conveyed along conveyor belt 102 in machine direction 30. As substrate 10 is conveyed, adhesive 20 is applied by nozzle 110. Then containers 50, having round footprint 40, are arranged into a configuration determined by using container arranging and affixing mechanism 120 and are then affixed to substrate 10 by contacting footprint 40 of containers 50 to adhesive 20 to form temporary assembly 60. The period of time between the applying of adhesive 20 to substrate 10 and affixing containers 50 to substrate 10 is generally less than about 10 seconds, in embodiments between about 1 and 5 seconds, in some embodiments between about 2 and 3 seconds. Adhesive 20 holds containers 50 firmly in place during subsequent operations and resists movement relative to each other and to the substrate and thus provides stability during normal handling leading to the formation of the finished assembly 80. Normal handling includes placement of optional cover layers, printed labels, etc. to the temporary assembly (not shown in FIG. 4), movement associated with abrupt stopping and starting of the conveyor belt, movement along inclines such as that shown in conveyor belt section 102a or around sharp turns (not shown in FIG. 4), and the like. To form finished assembly 80, temporary assembly 60 is conveyed along conveyor belt 102 in an upward incline direction 32 along inclined conveyor belt section 102a to reach a second level portion of conveyor belt 102b where it is conveyed in machine direction 34 toward plastic wrap applicator 130. Upon reaching plastic wrap applicator 130, temporary assembly 60 has plastic wrap 132 applied to the substrate 10, adhesive 20, and containers 50 to form finished assembly 80, at which point plastic wrap 132 is severed from the plastic wrap applicator 130 by knife 140. In the finished assembly, plastic wrap 132 acts to hold containers 50 in place relative to one another and relative to substrate 10. Finished assembly 80 no longer requires adhesive 20 to maintain the relative positions of containers 50 in the assembly. Accordingly, adhesive 20 has either lost all measurable adhesion by the time plastic wrap 132 is applied, or loses all measurable adhesion within a period of time, for example several minutes, after formation of finished assembly 80 is complete. Finished assembly 80 thus contains substrate 10, adhesive 20 wherein the adhesive 20 has lost adhesive properties, containers 50, and plastic wrap 132.

Finished assemblies formed using methods similar to that depicted in FIG. 4 are suitably formed using packaging assembling systems sold by Delkor Systems, Inc. of Circle Pines, Minn. under the trademark Spot-Pak®. Video representations of one such system is provided by Delkor at http://www.delkorsystems.com/spot_pak_video.html.

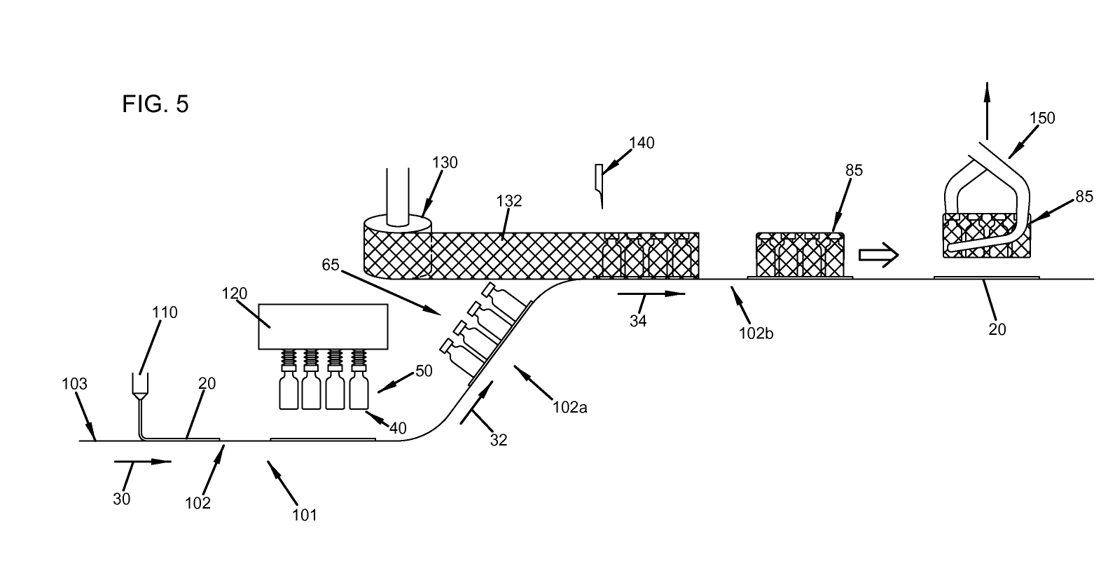

FIG. 5 shows an alternative embodiment of a method of forming a finished assembly of the invention. Referring to FIG. 5, a packaging assembling setup 101 is shown, including a conveyor belt 102 having a surface 103 designed to receive a fugitive adhesive of the invention, adhesive application nozzle 110, container arranging and affixing mechanism 120, plastic wrap applicator 130, knife 140, and clamping and lifting mechanism 150. Adhesive 20 is applied by nozzle 110 directly onto surface 103 of conveyor belt 102, wherein surface 103 of conveyor belt 102 is adapted to receive adhesive 20. Then containers 50, having footprint 40, are arranged into a configuration determined by using container arranging and affixing mechanism 120 and then affixed to conveyor belt surface 103 by contacting footprint 40 of containers 50 to adhesive 20 to form temporary assembly 65. Adhesive 20 holds containers 50 firmly in place during subsequent operations and resists movement relative to each other and to the conveyor belt 102 and thus provides stability during normal handling leading to the formation of the finished assembly 85. To form finished assembly 85, temporary assembly 65 is conveyed along conveyor belt 102 in an upward incline direction 32 along inclined conveyor belt section 102a to reach a second level portion of conveyor belt 102b where it is conveyed in machine direction 34 toward plastic wrap applicator 130. Upon reaching plastic wrap applicator 130, temporary assembly 65 has plastic wrap 132 applied to containers 50 to form finished assembly 85, at which point plastic wrap 132 is severed from the plastic wrap applicator 130 by knife 140. In the finished assembly, plastic wrap 132 acts to hold containers 50 in place relative to one another. Finished assembly 85 no longer requires adhesive 20 to maintain the relative positions of containers 50 in the assembly. Accordingly, adhesive 20 has either lost all measurable adhesion by the time plastic wrap 132 is applied, or loses all measurable adhesion within a period of time, for example several minutes, after formation of finished assembly 85 is complete. Finished assembly 85 thus contains containers 50, and plastic wrap 132. Upon loss of adhesion by adhesive 20, clamping and lifting mechanism 150 clamps finished assembly 85 and lifts it off of the conveyor belt 102 for stacking, storage, shipping, or a combination of one or more thereof. Adhesive 20 remains associated with conveyor belt surface 103 unless and until it is removed by a means not shown in FIG. 4 and disposed of or recycled by adding it back into a hopper that feeds adhesive applicator nozzle 110. In embodiments adhesive 20 is no longer adhered to conveyor belt surface 103 and therefore falls off conveyor belt 102 for disposal or recycling.

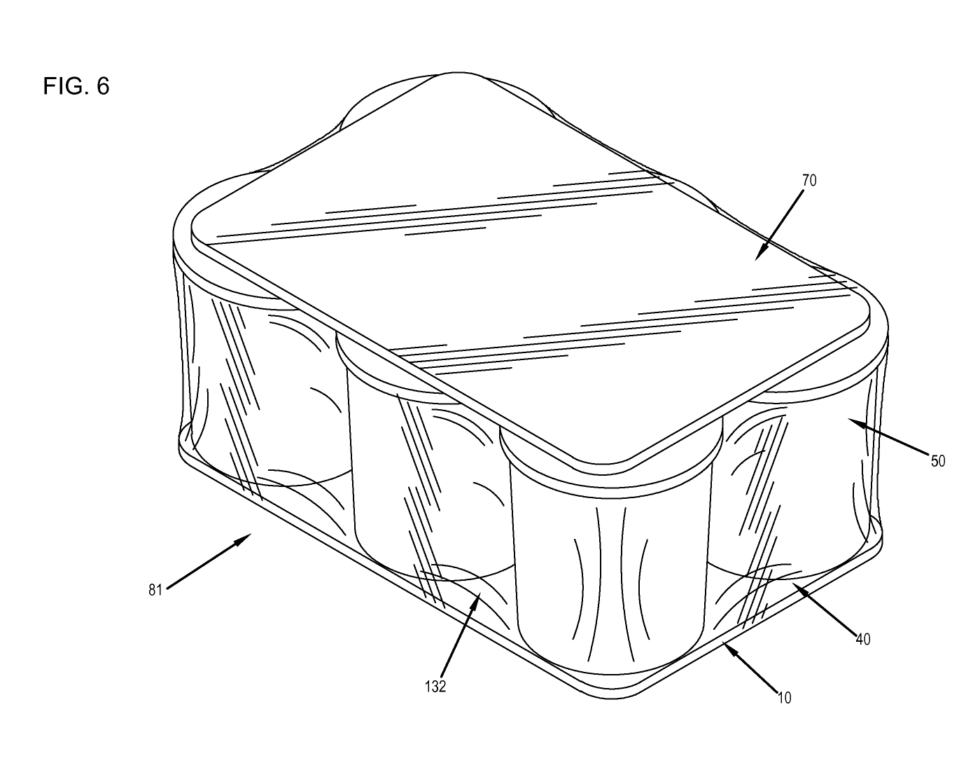

One embodiment of a finished assembly according to the present invention is shown at FIG. 6. Finished assembly 81 has a substrate 10 that is a flat base member, containers 50 having footprint 40 situated on top of a major surface of substrate 10, and plastic wrap 132 applied around the assembly. Not visible in the finished assembly is the fugitive adhesive of the invention, which is disposed between substrate 10 and containers 50, specifically situated underneath footprint 40. In finished assembly 81, the fugitive adhesive of the invention has lost adhesive properties and no longer acts to hold containers 50 on substrate 10. A cover member 70 is situated on top of the containers 50 and within the plastic wrap 132. Cover member 70 provides added strength to the finished assembly 81 and offers protection for containers 50. Such protection is important where containers 50 employ paper or foil lids, for example. Cover member 70 is applied between the affixing of the containers 50 to substrate 10 and before applying plastic film 132 to form the finished assembly 81. In some embodiments, plastic film 132 is a shrink wrap film such as shrink wrap film commercially available from Armin Plastics of Tulsa, Okla. as Product No. 2304B. The encapsulation afforded by plastic film 132 keeps cover 70 tightly pressed to the tops of the containers 50 which in turn increases the integrity and robustness of finished assembly 81 strength and protects the top of the containers 50.

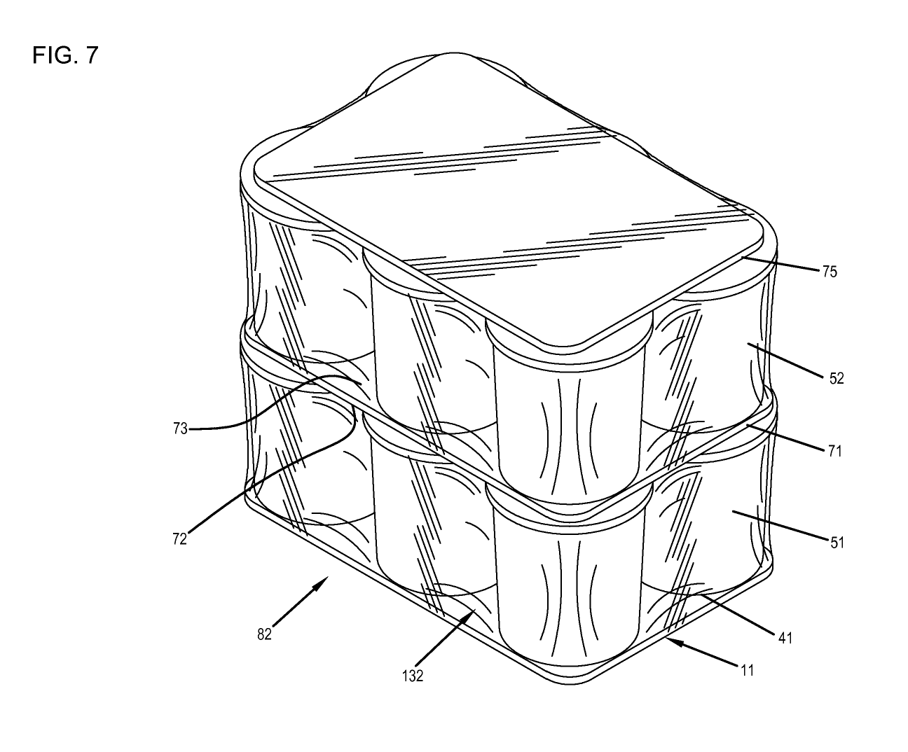

An alternative embodiment of a finished assembly according to the present invention is shown in FIG. 7. Finished assembly 82 has a substrate 11 and a plurality of containers 51 having footprint 41 situated on top of a major surface of substrate 11. The fugitive adhesive of the invention, not visible in FIG. 7, is disposed between substrate 11 and containers 51, specifically situated underneath footprint 41. A cover member 71 having a bottom major surface 72 and top major surface 73 is situated on top of containers 51. Cover member 71 acts both as a cover member for containers 51 and as a second substrate, wherein bottom major surface 72 covers containers 51 and top major surface 73 has disposed thereon a second layer of strips or patches of a fugitive adhesive of the invention; and disposed on the top major surface 73 of cover member 71 is a second plurality of containers 52 in a manner substantially similar to the disposition of containers 51 on substrate 11. A second cover member 75 is situated on top of containers 52, and plastic wrap 132 applied around the assembly. In finished assembly 82, the fugitive adhesive of the invention has lost adhesive properties and no longer acts to hold containers 51 on substrate 11 or containers 52 on top major surface 73 of cover member 71. A cover member 70 is situated on top of the containers 50 and within the plastic wrap 132.

Stacked embodiments of the finished assemblies of the invention include various embodiments of stacked temporary or finished assembly “layers” that include a plurality of substrate/cover members, a plurality of areas or major surfaces wherein the fugitive adhesive of the invention is disposed, and pluralities of containers, items, or components. In some embodiments, each discrete layer is assembled separately as a temporary assembly, then a group of two or more temporary assemblies are stacked together and wrapped, for example by one or more layers of plastic wrap, to form the finished assembly. In other embodiments, layer is assembled one on top of another, until the desired number of layers is formed; then the stack of layers is wrapped to form the finished assembly. In all such embodiments, the fugitive adhesive of the invention is disposed between substrate and the plurality of containers, items, or components to hold them firmly in place as the layers are assembled and stacked and loses adhesion only after the finished assembly is complete.

In embodiments, the fugitive adhesive compositions of the invention are applied to a substrate to adhesively hold a group of containers or items in a particular formation relative to one another on the substrate during a packaging operation; then after packaging to form the finished assembly, the fugitive adhesives lose adhesive bond strength, thereby permitting disassembly of the finished assembly, e.g. by a consumer or by a retail store stockperson. In some embodiments, the method further includes disassembly of the assembly. The fugitive adhesive compositions of the invention release cleanly from the substrate after the fugitive adhesive bond time, thus allowing for ease of disassembly at a designated time. Thus, disassembly is carried out, in various embodiments, on the temporary assembly after the fugitive adhesive bond time, or on the finished assembly. In some such embodiments, disassembly is carried out on the finished assembly. In some embodiments upon disassembly the adhesion level of the fugitive adhesive compositions of the invention is very low, unmeasurable, or zero. In some embodiments, upon disassembly there is little or no adhesive residue on the one or more containers, items, or components. In some embodiments, upon disassembly there is little or no adhesive residue on the substrate. In some embodiments, upon disassembly the majority of the fugitive adhesive composition resides on discardable items. In other embodiments, upon disassembly the fugitive adhesive composition falls off of all solid surfaces completely.

In some embodiments, the assembling, the applying of the fugitive adhesive of the invention, or both is carried out at elevated temperatures. In some embodiments, disassembly is carried out at elevated temperature. In other embodiments, the disassembly is carried out at ambient temperature. In still other embodiments, the disassembly is carried out below ambient temperature.

### EXPERIMENTAL SECTION

Fugitive adhesive compositions were evaluated for viscosity by using a Brookfield Viscosity measurement device according to ASTM test method D3236. Formulations were analyzed using a Brookfield LVDV II+ viscometer, HT-2 Sample Chamber and a number 27 spindle with a rotation speed of 20 rotations per minute. A sample chamber was filled with 10 grams of each formulation and then placed into the Thermosel that had been preheated to the target temperature and allowed to stabilize for 10 minutes. After the sample chamber had come to temperature the spindle was inserted. When the spindle was in place, the sample was equilibrated for 30 minutes, and the first viscosity was measured at the target temperature. If a second temperature reading was required, the temperature was then increased to the next target temperature and the viscosity recorded again after an additional 30 minutes at the second target temperature. Subsequent measurements were taken similarly, increasing the temperature and allowing 30 minutes of equilibration before a viscosity measurement was taken.

The Gardner color index of the non-permanent adhesive formulation was determined by ASTM D1544—Standard Test Method for Color of Transparent Liquids (Gardner Color Scale).

Some of the compositions were subjected to the Fugitive Adhesive Bond Time test, which is described elsewhere in the specification and is also reproduced here:

### Fugitive Adhesive Bond Time Test

This is a detailed explanation of the test procedure used to measure the fugitive adhesive bond as reported in this disclosure and as claimed. Use of this test procedure will satisfy the test adhesive properties that are recited in the claims. The purpose of the test is to show that the bond is temporary in the sense that it can maintain a bond between an article and a paperboard substrate until such time the bonded article is sent to a next step in the packaging process.
1. Prepare substrates for testing.
   a. Referring to FIG. 1, fasten the long sides 102 of a piece of primary substrate 100, minimum sheet size 100 mm by 280 mm, to a substantially horizontal, flat, smooth surface 110 using two strips of pressure sensitive adhesive tape 120. As used herein, “primary substrate” refers to 56# high performance corrugated board stock obtained from Inland Container Corporation of Austin, Tex. or an equivalent board stock.
   b. Prepare 5 pieces of 0.254 mm (10 mil) polypropylene film (or equivalent polymeric 10 mil film) into strips 76 mm (3 in.) in length and 13 mm (0.5 in.) in width.
2. Prepare the test fugitive adhesive composition for testing.
   a. Add 300±10 g of a test fugitive adhesive composition to a 600 mL glass beaker and cover with a watch glass. Place the beaker containing the adhesive into the oven set to a temperature of 177° C. and heat until the adhesive is molten, approximately one hour.
   b. Concurrently heat an adhesive Precision Wet Film applicator (5.08 cm (2 inches) wide with a 0.254 mm (10 mil) gap; obtained from Precision Gauge and Tool Company of Dayton, Ohio) in the same oven for one hour.
   c. Remove the molten test fugitive adhesive composition from the oven, and using a thermocouple or a thermometer, verify that the temperature is at 177+/−5° C.
   d. Remove the adhesive applicator from the oven. Referring to FIG. 1, place the applicator in a first position 130 at a second side 104 of primary substrate 100. Place the applicator gap face down and in contact with primary substrate 100. Fill the applicator reservoir with the molten test fugitive adhesive composition.
3. Start the test (time=0).
   a. Referring again to FIG. 1, move the applicator containing the molten test fugitive adhesive composition from first position 130 in direction 134 to second position 132 in a single, smooth motion so as to deposit a single, uniform adhesive layer 200. The time to traverse the path from first position 130 to second position 132 is approximately 2 seconds.
   b. Immediately after applying adhesive layer 200 to primary substrate 100, place the polypropylene strips crosswise on the molten adhesive film as shown by positions 300, separating each strip by gap 302, wherein gap 302 is approximately 2 cm. Lightly press each strip into the adhesive film 200, using hand pressure, to assure complete adhesive wet-out. Using this method, apply all 5 polypropylene strips to positions 300 within 10 seconds of the application of adhesive film 200.
   c. Start a timer after the last polypropylene strip is applied.
4. Complete the test.
   a. After an interval of 5:00 minutes has elapsed on the timer, grasp edge 304 of a polypropylene strip and lift in a direction generally perpendicular to the plane of the surface of the primary substrate 100 to debond. Repeat for the remaining strips.
   b. Observe the area under the debonded polypropylene strips. Record observations of
      i. any tearing of the primary substrate, and
      ii. location of adhesive residue: all on the primary substrate, all on the polypropylene strip; or some residue on both the primary substrate and the polypropylene strip.
   c. If 4 of the 5 polypropylene strips debond without tearing of the primary substrate and without leaving adhesive residue on the primary substrate, a result of “pass” is recorded.
5. Repeat the test at a longer interval if less than 4 of the 5 bonds do not pass according to 4.c.
   a. Steps 1-4 are repeated using the same test fugitive adhesive composition and selecting an interval of more than 5:00 minutes in step 4.a.
   b. The test is repeated at longer selected intervals until a “pass” is determined according to 4.c. A result of “pass” is recorded for the selected interval.
6. A result of “pass” and the associated time interval means that the test fugitive adhesive bond time is less than or equal to the stated time interval.

### Example 1

The following materials by weight percent of the total composition were used to make a fugitive adhesive composition:

| | | Wgt % of |
|---|---|---|
| Raw Material | Supplier | composition |
| SASOLWAX ® H-1 | Sasol Chemical Industries of | 40.0 |
| | Johannesburg, South Africa | |
| ESCOREZ ® 5400 | ExxonMobil Corporation of | 39.8 |
| (tackifier) | Irving, TX | |
| KRATON ® SBC G- | Kraton Polymers U.S. LLC | 20.0 |
| 1652 | of Houston, TX | |
| IRGANOX ® 1010 | Ciba Geigy Ltd. of Basel, | 0.2 |
| | Switzerland | |

To form the composition, ESCOREZ® 5400 was added to a vessel and heated for 10 minutes. Mechanical mixing was started at a moderate rate of speed while the KRATON® and IRGANOX® materials were slowly added over the next 25 minutes. While mixing was continued, the wax was slowly added over a 15-minute period. The composition was then allowed to mix an additional 15 minutes to assure uniformity. The final composition temperature was 350-360° F.

A portion of the composition was removed for analysis. The composition was found to have a molten Gardner Color of 1-2, Brookfield Thermosel Viscosity (spindle SC4-29) of 2900 cP at 300° F., 1300 cP at 325° F., and 730 cP at 350° F. The Mettler softening point was determined to be 222° F.

While still molten and at a temperature of about 350° F., a bead of the adhesive composition, 3/16th of an inch in diameter, was applied in a 12 inch long strip to a piece of 40# Kraft paper affixed to a solid, bench top surface. A timer was started immediately after the bead application and within 5 seconds of the start of the application to the Kraft paper. Strips of 20 mil thick polypropylene film 0.5″ wide and 2″ long were laid perpendicularly and bonded to the composition bead while still molten. All of the strips were bonded to the bead within fifteen seconds of the initial composition application. The bead was allowed to cool at room temperature. The polypropylene strips were removed at thirty-second intervals by grabbing both ends simultaneously and pulling them upward in a generally perpendicular direction from the Kraft paper surface. As each polypropylene strip was removed, the approximate % of Kraft paper fiber tear was recorded for each removed polypropylene strip, as shown in Table 1. One hundred percent fiber tear indicates more than sufficient strength to form an initial bond.

TABLE 1
Bond Strength Test Results

| Time, s | Percent Kraft paper fiber tear (%) |
|---|---|
| 30 | 100 |
| 60 | 100 |
| 90 | 100 |
| 120 | 0 (tight) tight bond) |
| 150 | 0 (loose) bond) |
| 180 | 0 |
| 210 | 0 |
| 240 | 0 |
| 270 | 0 |

The data shows that the composition has sufficient adhesive properties to initially bond plastic containers (represented by polypropylene film) and corrugated pads (Kraft paper), but these adhesive properties are transient and disappear after about 120-150 seconds, which is the fugitive adhesive bond time of the composition. After about 120 seconds, the containers can be removed without paper fiber tear. After about 150 seconds, the adhesion level is reduced further.

### Example 2

Using the technique employed to blend the composition of Example 1, the following composition was formed:

| | | Wgt % of |
|---|---|---|
| Raw Material | Supplier | composition |
| Nat 155 soy wax | Marcus Oil and Chemical Corp. of | 50.0 |
| | Houston, TX | |
| ESCOREZ ® 5400 | ExxonMobil Corporation of | 19.5 |
| | Irving, TX | |
| VECTOR ® 6241A | Dexco Polymers LP of Houston, TX | 30.0 |
| IRGANOX ® 1010 | Ciba Geigy Ltd. of Basel, | 0.5 |
| | Switzerland | |

A portion of the composition was removed for analysis. The composition was found to have a molten Gardner Color of 2-3, Brookfield Thermosel Viscosity (spindle SC4-29) of 12,300 cP at 250° F., 1825 cP at 300° F., and 800 cP at 350° F. The Mettler softening point was determined to be 176° F.

### Example 3

Using the technique employed to blend the composition of Example 1, the following composition was formed:

| | | Wgt % of |
|---|---|---|
| Raw Material | Supplier | composition |
| Nat 155 soy wax | Marcus Oil and Chemical Corp. of | 50.0 |
| | Houston, TX | |
| EPOLENE ® C-18 | Westlake Chemical Corp. of | 5.0 |
| | Houston, TX | |
| ESCORENE ® UL- | ExxonMobil Chemical Company of | 29.5 |
| 7750 | Houston, TX | |
| 150 Paraffin Wax | ExxonMobil Chemical Company of | 15 |
| | Houston, TX | |
| IRGANOX ® 1010 | Ciba Geigy Ltd. of Basel, | 0.5 |
| | Switzerland | |

A portion of the composition was removed for analysis. The composition was found to have a molten Gardner Color of 2-3, Brookfield Thermosel Viscosity (spindle SC4-29) of 1650 cP at 300° F., 1150 cP at 325° F., and 850 cP at 350° F. The Mettler softening point was determined to be 160° F.

### Examples 4-7

Using the technique employed to blend the composition of Example 1, the following compositions was formed:

| | | Wgt % of Composition | | | |
|---|---|---|---|---|---|
| Raw Material | Supplier | Ex. 4 | Ex. 5 | Ex. 6 | Ex. 7 |
| Nat 155 soy wax | Marcus Oil and Chemical | 30.0 | 40.0 | 50.0 | 60.0 |
| | Corp. of Houston, TX | | | | |
| SYLVALITE ® | Arizona Chemical | 40.0 | 30.0 | 20.0 | 10.0 |
| RE 100L | Company of | | | | |
| | Jacksonville, FL | | | | |
| ESCORENE ® | ExxonMobil Corporation | 25.0 | 25.0 | 25.0 | 25.0 |
| UL-7760 | of Irving, TX | | | | |
| ESCORENE ® | ExxonMobil | 5.0 | 5.0 | 5.0 | 5.0 |
| UL-7710 | | | | | |

Aliquots of the compositions were measured for viscosity at 300° F. and 350° F. using the methods described above and were then subjected to the Fugitive Adhesive Bond Time test outlined above. The results of these analyses are listed in Table 2.

TABLE 2
Results of Viscosity, Fugitive Adhesive Bond Time of Ex. 4-7

| | | | Fugitive | |
|---|---|---|---|---|
| | | | Adhesive | |
| | Viscosity, | Viscosity, | Bond | |
| Example | cP | cP | Pass | |
| No. | at 300° F. | at 350° F. | Time* | Mode of release |
| 4 | 7900 | 3360 | >24 hours | Primary substrate tear |
| 5 | 5530 | 2600 | 10 min | PP/adhesive split; clean |
| 6 | 4390 | 2100 | 10 min | PP/adhesive split; clean |
| 7 | 3350 | 1680 | 5 min | PP/adhesive split; clean |

*Time listed represents the maximum time to a rating of “pass.”

The above analyses show that 40 wgt % or more of soy wax, in conjunction with the polymer and tackifier employed in the formulation, forms a fugitive adhesive capable of clean release in less than 24 hours after application. In each of Examples 5-7, the adhesive released cleanly from the polypropylene strip at the maximum fugitive adhesive bond time, leaving no observable residue.

### Examples 8-10

Using the technique employed to blend the composition of Example 1, the following compositions was formed:

| | | Wgt % of | | |
|---|---|---|---|---|
| | | Composition | | |
| Raw Material | Supplier | Ex. 8 | Ex. 9 | Ex. 10 |
| Nat 155 soy wax | Marcus Oil and Chemical | 40.0 | 50.0 | 60.0 |
| | Corp. of Houston, TX | | | |
| EPOLINE ® C- | Westlake Chemical of | 5.0 | 5.0 | 5.0 |
| 18 | Houston, TX | | | |
| Paraffin 150 | ExxonMobil Corporation | 25.0 | 15.0 | 5.0 |
| | of Irving, TX | | | |
| ESCORENE ® | ExxonMobil Corporation | 30.0 | 30.0 | 30.0 |
| UL-7750 | of Irving, TX | | | |

Aliquots of the compositions were measured for viscosity at 300° F. and 350° F. using the methods described above and were then subjected to the Fugitive Adhesive Bond Time test outlined above. The results of these analyses are listed in Table 3.

TABLE 3
Results of Viscosity, Fugitive Adhesive Bond Time of Ex. 8-10

| | | | Fugitive | |
|---|---|---|---|---|
| | | | Adhesive | |
| | Viscosity, | Viscosity, | Bond | |
| Example | cP | cP | Pass | |
| No. | at 300° F. | at 350° F. | Time* | Mode of release |
| 8 | 1750 | 900 | 5 min. | PP/adhesive split; clean |
| 9 | 1650 | 850 | 5 min. | PP/adhesive split; clean |
| 10 | 2140 | 1080 | 5 min. | PP/adhesive split; clean |

*Time listed represents the maximum time to a rating of “pass.”

The above analyses show that fugitive adhesive compositions of the invention do not require a tackifier to form a fugitive adhesive capable of clean release in less than 24 hours after application. In each of Examples 8-10, the adhesive released cleanly from the polypropylene strip at the maximum fugitive adhesive bond time, leaving no observable residue.

### Examples 11-14

Using the technique employed to blend the composition of Example 1, the following compositions was formed:

| | | Wgt % of | | | |
|---|---|---|---|---|---|
| | | Composition | | | |
| | | Ex. | Ex. | Ex. | Ex. |
| Raw Material | Supplier | 11 | 12 | 13 | 14 |
| Nat 155 soy wax | Marcus Oil and Chemical | 30.0 | 40.0 | 50.0 | 60.0 |
| | Corp. of Houston, TX | | | | |
| ESCOREZ ® | ExxonMobil Corporation | 40.0 | 30.0 | 20.0 | 10.0 |
| 5400 | of Irving, TX | | | | |
| VECTOR ® | Dexco Polymers LP, of | 30.0 | 30.0 | 30.0 | 30.0 |
| 6421A | Houston, TX | | | | |

Aliquots of the compositions were measured for viscosity at 300° F. and 350° F. using the methods described above and were then subjected to the Fugitive Adhesive Bond Time test outlined above. The results of these analyses are listed in Table 4.

TABLE 4
Results of Viscosity, Fugitive Adhesive Bond Time of Ex. 11-14

| | | | Fugitive | |
|---|---|---|---|---|
| | | | Adhesive | |
| | Viscosity, | Viscosity, | Bond | |
| Example | cP | cP | Time, | |
| No. | at 300° F. | at 350° F. | max* | Mode of release |
| 11 | 3800 | 1700 | >24 hours | Primary substrate tear |
| 12 | 2620 | 1300 | >24 hours | Primary substrate tear |
| 13 | 2180 | 1080 | 5 min | PP/adhesive split; clean |
| 14 | 1600 | 780 | 5 min | PP/adhesive split; clean |

*Time listed represents the maximum time to a rating of “pass.”

The above analyses show that a 50 wgt % or more of soy wax, in conjunction with the polymer and tackifier employed in the compositions, form a fugitive adhesive capable of clean release in less than 24 hours after application. In each of Examples 13-14, the adhesive released cleanly from the polypropylene strip at the maximum fugitive adhesive bond time, leaving no observable residue.

While the above specification shows an enabling disclosure of the adhesive technology of the invention, other embodiments of the invention may be made without departing from the spirit and scope of the invention. In the claims recitation of an element does not exclude having more than one of the elements. Accordingly, the invention is embodied in the claims hereinafter appended.

We claim:

1. A fugitive hot melt adhesive composition comprising
a) a base polymer,
b) a tackifying resin, and
c) about 40-80% by weight relative to the total weight of the composition of a vegetable wax;
wherein the composition has a fugitive adhesive bond time of up to 60 minutes, the fugitive adhesive bond time being defined as a test measurement of the time wherein, after applying a bead of the molten composition from a 5.08 cm wide, 0.254 mm thick gap onto a paperboard substrate, and further after applying 0.254 mm thick polypropylene film to the composition bead within about 10 seconds of applying the composition bead to the paperboard, the polypropylene film releases cleanly from the composition when pulled in perpendicular direction from the paperboard.

2. The fugitive hot melt adhesive of claim 1 wherein the base polymer comprises a styrene-butadiene block copolymer.

3. The fugitive hot melt adhesive of claim 2 wherein the styrene-butadiene-styrene triblock copolymer comprises less than 2% by weight of triblock content, and is present at about 20% to 40% by weight of the composition.

4. The fugitive hot melt adhesive of claim 1 wherein the base polymer comprises an ethylene-vinyl acetate copolymer.

5. The fugitive hot melt adhesive of claim 4 wherein the ethylene vinyl acetate copolymer comprises 28% vinyl acetate, and is present at about 20% to 40% by weight of the composition.

6. The fugitive hot melt adhesive of claim 1 wherein the vegetable wax is a soybean wax.

7. The fugitive hot melt adhesive of claim 6 wherein the soybean wax is present in the composition at about 40% to 60% by weight of the composition.

8. The fugitive hot melt adhesive of claim 6 wherein the soybean wax is present in the composition at about 50% by weight of the composition.

9. The fugitive hot melt adhesive of claim 1 wherein the fugitive adhesive bond time is equal to or less than about 10 minutes.

10. The fugitive hot melt adhesive of claim 1 wherein the composition further releases cleanly from the paperboard within the fugitive adhesive bond time.

11. An assembly comprising
a) one or more containers, items, or components,
b) one or more substrates; and
c) one or more areas having a fugitive adhesive composition disposed between the one or more containers, goods, items, or components, and the one or more substrates;
wherein the fugitive adhesive composition comprises a base polymer, a tackifying resin, and 40%-80% by weight relative to the total weight of the composition of a vegetable wax; and wherein the composition has a fugitive adhesive bond time of up to 60 minutes, the fugitive adhesive bond time being defined as a test measurement of the time wherein, after applying a bead of the molten composition from a 5.08 cm wide, 0.254 mm thick gap onto a paperboard substrate, and further after applying 0.254 mm thick polypropylene film to the composition bead within about 10 seconds of applying the composition bead to the paperboard, the polypropylene film releases cleanly from the composition when pulled in perpendicular direction from the paperboard.

12. The assembly of claim 11 wherein the assembly further comprises one or more means to secure the assembly after the open time of the fugitive adhesive elapses.

13. The assembly of claim 12 wherein the one or more means includes an opaque, transparent, or translucent plastic wrap.

14. The assembly of claim 13 wherein the plastic wrap comprises a shrink-wrap.

15. The assembly of claim 11 wherein the substrate is a flat base member comprising chipboard, cardboard, paper, paperboard, rigid or flexible plastic, metal sheeting, foam sheeting, or combinations of one or more layers thereof, composites thereof, blends thereof, or multilayer substrates composed of one or more thereof wherein the flat base member comprises at least one major surface having the fugitive adhesive and one or more containers, items, or components disposed thereon.

16. The assembly of claim 11 wherein the substrate is an additional one or more containers, items, or components.

17. The assembly of claim 11 wherein the one or more containers, items, or components are one or more containers containing comestibles.

18. The assembly of claim 11 further comprising one or more additional objects comprising clear or opaque plastic sheeting or wrapping, elastic bands, wire or plastic ties, cover members, rigid plastic or cardboard sheets or members, printed images or data, dividers, cloth, clips, hook and loop fasteners, nonwoven sheets, foam sheets, formed foam members, foam peanuts, desiccants, decorations, and the like, or combinations thereof.

19. The assembly of claim 11 further comprising one or more additional layers, wherein each layer comprises one or more additional containers, items, or components, one or more additional substrates, and one or more additional areas having a fugitive adhesive composition disposed between the one or more additional containers, goods, items, or components, and the one or more additional substrates.

20. A method of forming an assembly, comprising
a) applying a fugitive adhesive to a substrate,
b) arranging one or more containers, items, or components in a desired arrangement; and
c) affixing the one or more containers, items, or components to the substrate with the fugitive adhesive disposed therebetween to form an assembly;
wherein the fugitive adhesive comprises a base polymer, a tackifying resin, and 40-80% by weight relative to the total weight of the composition of a vegetable wax, and wherein the composition has a fugitive adhesive bond time of up to 60 minutes, the fugitive adhesive bond time being defined as a test measurement of the time wherein, after applying a bead of the molten composition from a 5.08 cm wide, 0.254 mm thick gap onto a paperboard substrate, and further after applying 0.254 mm thick polypropylene film to the composition bead within about 10 seconds of applying the composition bead to the paperboard, the polypropylene film releases cleanly from the composition when pulled in perpendicular direction from the paperboard

21. The method of claim 20 further comprising carrying out one or more additional operations on the assembly to form a finished assembly.

22. The method of claim 21 wherein the one or more additional operations includes wrapping the assembly in a plastic wrap comprising a shrink-wrap.

23. The method of claim 21 wherein the one or more additional operations is coating, painting, curing, UV irradiating, conveying, inserting dividers, wrapping, stacking of additional assemblies onto the assembly, or a combination of one or more thereof.

24. The method of claim 21 wherein the substrate is removed from the finished assembly.

25. The method of claim 21 wherein the substrate and fugitive adhesive are removed from the finished assembly.

26. The method of claim 20 wherein the applying is carried out between about 110° C. and 200° C.

27. The method of claim 20 wherein the applying comprises dispensing strips, intermittent strips, or patches from a nozzle onto the substrate.

28. A fugitive hot melt adhesive composition comprising
a base polymer and about 40-80% by weight relative to the total weight of the composition of a vegetable wax;
the composition characterized by the absence of a tackifying resin;
wherein the composition has a fugitive adhesive bond time of up to 60 minutes, the fugitive adhesive bond time being defined as a test measurement of the time wherein, after applying a bead of the molten composition from a 5.08 cm wide, 0.254 mm thick gap onto a paperboard substrate, and further after applying 0.254 mm thick polypropylene film to the composition bead within about 10 seconds of applying the composition bead to the paperboard, the polypropylene film releases cleanly from the composition when pulled in perpendicular direction from the paperboard.

29. The fugitive hot melt adhesive of claim 1 wherein the base polymer comprises an ethylene-vinyl acetate copolymer.

30. The fugitive hot melt adhesive of claim 29 wherein the ethylene vinyl acetate copolymer comprises 28% vinyl acetate, and is present at about 20% to 40% by weight of the composition.

31. The fugitive hot melt adhesive of claim 28 wherein the vegetable wax is a soybean wax.

32. The fugitive hot melt adhesive of claim 31 wherein the soybean wax is present in the composition at about 40% to 60% by weight of the composition.

33. The fugitive hot melt adhesive of claim 28 wherein the fugitive adhesive bond time is up to 5 minutes.

34. The fugitive hot melt adhesive of claim 28 wherein the composition further releases cleanly from the paperboard within the fugitive adhesive bond time.

35. An assembly comprising
a) one or more containers, items, or components,
b) one or more substrates; and
c) one or more areas having a fugitive adhesive composition disposed between the one or more containers, goods, items, or components, and the one or more substrates;
wherein the fugitive adhesive composition comprises a base polymer and 40-80% by weight relative to the total weight of the composition of a vegetable wax; the composition characterized by the absence of a tackifying resin; and wherein the composition has a fugitive adhesive bond time of up to 60 minutes, the fugitive adhesive bond time being defined as a test measurement of the time wherein, after applying a bead of the molten composition from a 5.08 cm wide, 0.254 mm thick gap onto a paperboard substrate, and further after applying 0.254 mm thick polypropylene film to the composition bead within about 10 seconds of applying the composition bead to the paperboard, the polypropylene film releases cleanly from the composition when pulled in perpendicular direction from the paperboard.

36. The assembly of claim 35 wherein the assembly further comprises one or more means to secure the assembly after the open time of the fugitive adhesive elapses.

37. The assembly of claim 36 wherein the one or more means includes an opaque, transparent, or translucent plastic wrap.

38. The assembly of claim 37 wherein the plastic wrap comprises a shrink-wrap.

39. The assembly of claim 35 wherein the substrate is a flat base member comprising chipboard, cardboard, paper, paperboard, rigid or flexible plastic, metal sheeting, foam sheeting, or combinations of one or more layers thereof, composites thereof, blends thereof, or multilayer substrates composed of one or more thereof; wherein the flat base member comprises at least one major surface having the fugitive adhesive and one or more containers, items, or components disposed thereon.

40. The assembly of claim 35 wherein the substrate is an additional one or more containers, items, or components.

41. The assembly of claim 35 wherein the one or more containers, items, or components are one or more containers containing comestibles.

42. The assembly of claim 35 further comprising one or more additional objects comprising clear or opaque plastic sheeting or wrapping, elastic bands, wire or plastic ties, cover members, rigid plastic or cardboard sheets or members, printed images or data, dividers, cloth, clips, hook and loop fasteners, nonwoven sheets, foam sheets, formed foam members, foam peanuts, dessicants, decorations, and the like, or combinations thereof.

43. The assembly of claim 35 further comprising one or more additional layers, wherein each layer comprises one or more additional containers, items, or components, one or more additional substrates, and one or more additional areas having a fugitive adhesive composition disposed between the one or more additional containers, goods, items, or components, and the one or more additional substrates.

44. A method of forming an assembly, comprising
a) applying a fugitive adhesive to a substrate,
b) arranging one or more containers, items, or components in a desired arrangement; and
c) affixing the one or more containers, items, or components to the substrate with the fugitive adhesive disposed therebetween to form an assembly;
wherein the fugitive adhesive comprises a base polymer and 40-80% by weight relative to the total weight of the composition of a vegetable wax; the composition being characterized by an absence of a tackifying resin; and wherein the composition has a fugitive adhesive bond time of up to 60 minutes, the fugitive adhesive bond time being defined as a test measurement of the time wherein, after applying a bead of the molten composition from a 5.08 cm wide, 0.254 mm thick gap onto a paperboard substrate, and further after applying 0.254 mm thick polypropylene film to the composition bead within about 10 seconds of applying the composition bead to the paperboard, the polypropylene film releases cleanly from the composition when pulled in perpendicular direction from the paperboard.

45. The method of claim 44 further comprising carrying out one or more additional operations on the assembly to form a finished assembly.

46. The method of claim 45 wherein the one or more additional operations includes wrapping the assembly in a plastic wrap comprising a shrink-wrap.

47. The method of claim 45 wherein the one or more additional operations is coating, painting, curing, UV irradiating, conveying, inserting dividers, wrapping, stacking of additional assemblies onto the assembly, or a combination of one or more thereof.

48. The method of claim 44 wherein the substrate is removed from the finished assembly.

49. The method of claim 44 wherein the substrate and fugitive adhesive are removed from the finished assembly.

50. The method of claim 44 wherein the applying is carried out between about 110° C. and 200° C.

51. The method of claim 44 wherein the applying comprises dispensing strips, intermittent strips, or patches from a nozzle onto the substrate.
